(19) United States
(12) Patent Application Publication
(10) Pub. No.: US 2008/0168563 A1
(43) Pub. Date: Jul. 10, 2008

(54) STORAGE MEDIUM STORING TERMINAL IDENTIFYING PROGRAM TERMINAL IDENTIFYING APPARATUS, AND MAIL SYSTEM

(75) Inventors: Yuji ITO, Fukuoka (JP); Shinichi Kuranari, Fukuoka (JP); Masaya Oda, Fukuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/971,039

(22) Filed: Jan. 8, 2008

(30) Foreign Application Priority Data
Jan. 10, 2007 (JP) JP2007-2859

(51) Int. Cl. G06F 21/00

(52) U.S. Cl. 726/24

(57) ABSTRACT

A terminal infected by an e-mail with a new virus is identified by storing information of e-mails as mail archive information, storing a distribution request history in which each distribution request of an email is associated with a terminal identification information which serves as a terminal information for identifying the terminal that has issued the distribution request, checking the mail archive and identifying an e-mail with a new virus, when definitions of new viruses have been added in a virus definition file, obtaining account information of the identified e-mail with the new virus, and extracting the terminal identification information of the terminal that issued the distribution request of the e-mail with the new virus, based upon both the obtained account information and the distribution request history.

### CROSS-REFERENCE TO RELATED APPLICATIONS

This application is related to and claims priority under 35 U.S.C §119(a) on Japanese Patent Application No. 2007-2859 filed on Jan. 10, 2007 in the Japan Patent Office, and incorporated by reference herein.

### BACKGROUND OF THE INVENTION

1. Field of the Invention

The present invention relates to recording media storing terminal identifying programs, terminal identifying apparatuses, and mail systems.

2. Description of the Related Art

Japanese Unexamined Patent Application Publication No. 2004-78648 discloses the following invention: A virus checking server in which a special protocol is embedded is provided, and the virus checking server checks communication data, such as e-mails which are sent or received by client users based upon the special protocol. When the virus checking server detects communication data having a computer virus (called a virus as follows) attached to the communication data, the virus checking server removes the virus.

Furthermore, Japanese Unexamined Patent Application Publication No. 2005-204055 discloses a network management system which identifies a terminal suffering from virus infection and disconnects from a network.

### SUMMARY OF THE INVENTION

According to an aspect of the present invention, there is provided a computer-readable storage medium storing a computer program for identifying a terminal infected by an e-mail with a new virus, said program causes a computer to perform the following operations of storing information of e-mails as mail archive information, distributing e-mails addressed to a terminal in response to a distribution request from the terminal, storing a distribution request history in which each distribution request is associated with a terminal identification information which serves as a terminal information for identifying the terminal that has issued the distribution request, checking the mail archive information of the e-mails on the basis of virus patterns stored in a virus definition file, identifying the terminal that has issued the distribution request of an e-mail with a new virus, the e-mail having the new virus, checking the mail archive information stored in the mail server and identifying the e-mail with the new virus, the e-mail having the new virus assigned to the e-mail, when definitions of new viruses have been added in the virus definition file, obtaining account information of the identified e-mail with the new virus, and extracting the terminal identification information of the terminal that has issued the distribution request of the e-mail with the new virus, as new-virus-infected-terminal identification information, with reference to both the account information obtained in the account-information obtaining and the distribution request history.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a diagram for explaining an overview of a mail system according to a first embodiment;

FIG. 2 is an operation flow diagram for explaining features of the mail system according to the first embodiment;

FIG. 3 is an operation flow diagram for explaining features of the mail system according to the first embodiment;

FIG. 4 is a block diagram showing the configuration of a mail server in the first embodiment;

FIG. 5 is a diagram for explaining a virus-definition-file storage unit;

FIG. 6 is a diagram for explaining a mail-archive-information storage unit of the mail server in the first embodiment;

FIG. 7 is a diagram for explaining an account-information obtaining unit of the mail server in the first embodiment;

FIG. 8 is a diagram for explaining a distribution-request-history storage unit of the mail server in the first embodiment;

FIG. 9 is a diagram for explaining an infected-terminal-identification-information extracting unit of the mail server in the first embodiment;

FIG. 10 is a diagram for explaining terminal identification information sent from the mail server to a router in the first embodiment;

FIG. 11 is a block diagram showing the configuration of the router in the first embodiment;

FIG. 12 is a diagram for explaining a path-information storage unit;

FIG. 13 is a diagram for explaining an infected-terminal determining unit;

FIG. 14 is a flow chart for explaining processing executed by the mail server in the first embodiment;

FIG. 15 is a flow chart for explaining processing executed by the router in the first embodiment;

FIG. 16 is a diagram for explaining an overview of a mail system according to a second embodiment;

FIG. 17 is an operation flow diagram for explaining features of the mail system according to the second embodiment;

FIG. 18 is an operation flow diagram for explaining features of the mail system according to the second embodiment;

FIG. 19 is a block diagram showing the configuration of a mail gateway in the second embodiment;

FIG. 20 is a diagram for explaining an account-information obtaining unit of the mail gateway in the second embodiment;

FIG. 21 is a diagram for explaining account information sent from the mail gateway to a mail server in the second embodiment;

FIG. 22 is a block diagram showing the configuration of the mail server according to the second embodiment;

FIG. 23 is a diagram for explaining a mail-archive-information storage unit of the mail server in the second embodiment;

FIG. 24 is a diagram for explaining a distribution-request-history storage unit of the mail server in the second embodiment;

FIG. 25 is a flow chart for explaining an infected-terminal-identification-information extracting unit of the mail server in the second embodiment;

FIG. 26 is a flow chart for explaining processing executed by the mail gateway in the second embodiment;

FIG. 27 is a flow chart for explaining processing executed by the mail server in the second embodiment;

FIG. 28 is a diagram for explaining an overview and features of a mail system according to a third embodiment;

FIG. 29 is a flow chart for explaining processing executed by a mail server in the third embodiment;

FIG. 30 is a diagram for explaining an overview of a mail system according to a fourth embodiment;

FIG. 31 is an operation flow diagram for explaining features of the mail system according to the fourth embodiment;

FIG. 32 is an operation flow diagram for explaining features of the mail system according to the fourth embodiment;

FIG. 33 is a diagram for explaining an infected-terminal-identification-information extracting unit of a mail server in the fourth embodiment;

FIG. 34 is a block diagram showing the configuration of an authentication server in the fourth embodiment;

FIG. 35 is a diagram for explaining an access-management-information storage unit;

FIG. 36 is a diagram for explaining an infected-terminal-identification-information extracting unit of the authentication server in the fourth embodiment;

FIG. 37 is a flow chart for explaining processing executed by the mail server in the fourth embodiment;

FIG. 38 is a flow chart for explaining processing executed by the authentication server in the fourth embodiment; and

FIG. 39 is a diagram showing a computer that executes a terminal identifying program recorded on a recording medium in the first embodiment.

### DETAILED DESCRIPTION OF THE PREFERRED EMBODIMENTS

Now, terminal identifying programs stored on storage media, terminal identifying apparatuses, and mail systems according to embodiments of the present invention will be described with reference to the accompanying drawings. The following description is directed to embodiments of a mail system which includes a mail server that executes a terminal identifying program stored on a storage medium. Hereinafter, the configuration and processing procedures of a mail system according to a first embodiment will be described. Then, similarly to the first embodiment, a mail system according to a second embodiment, a mail system according to a third embodiment, a mail system according to a fourth embodiment, and a mail system according to other embodiments will be described in order.

### First Embodiment

Overview and features of mails system according to the first embodiment.

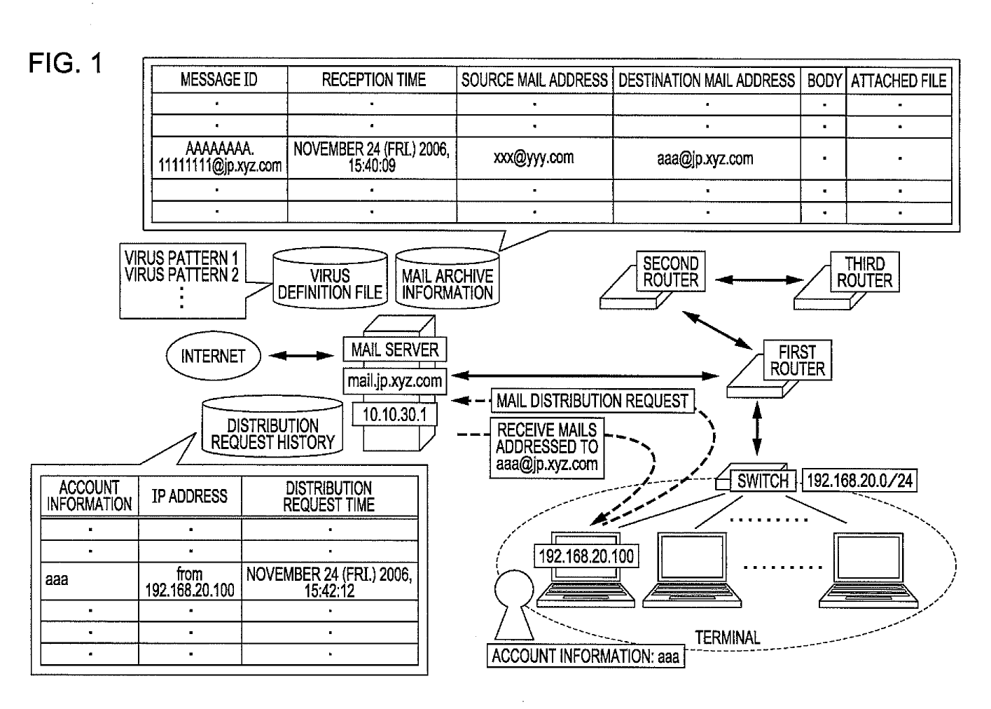

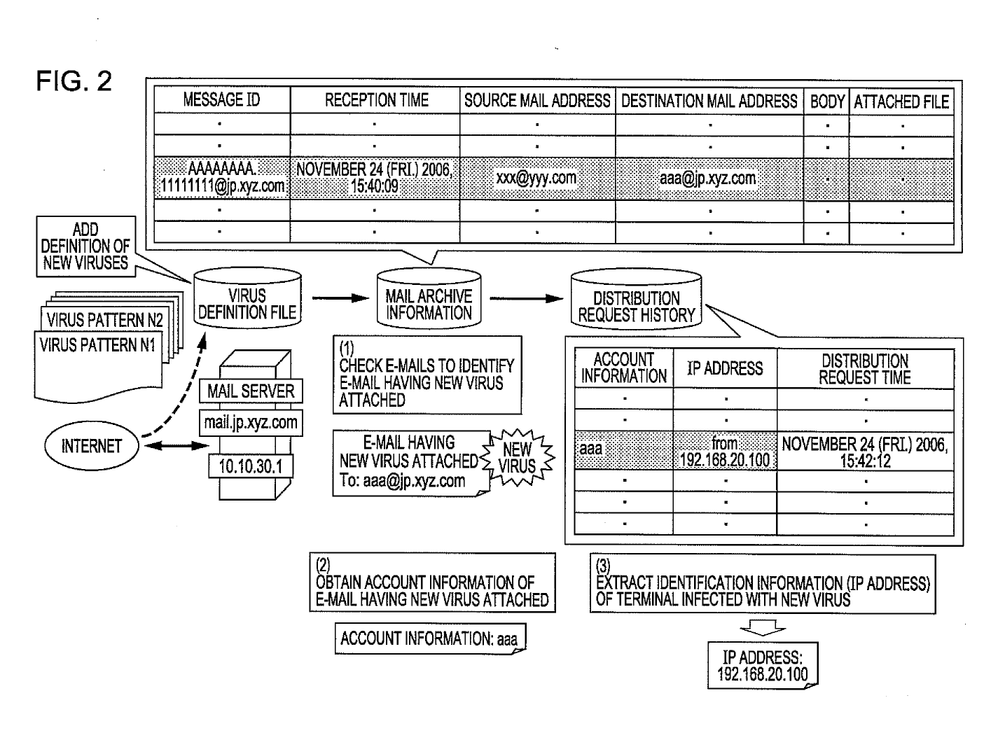

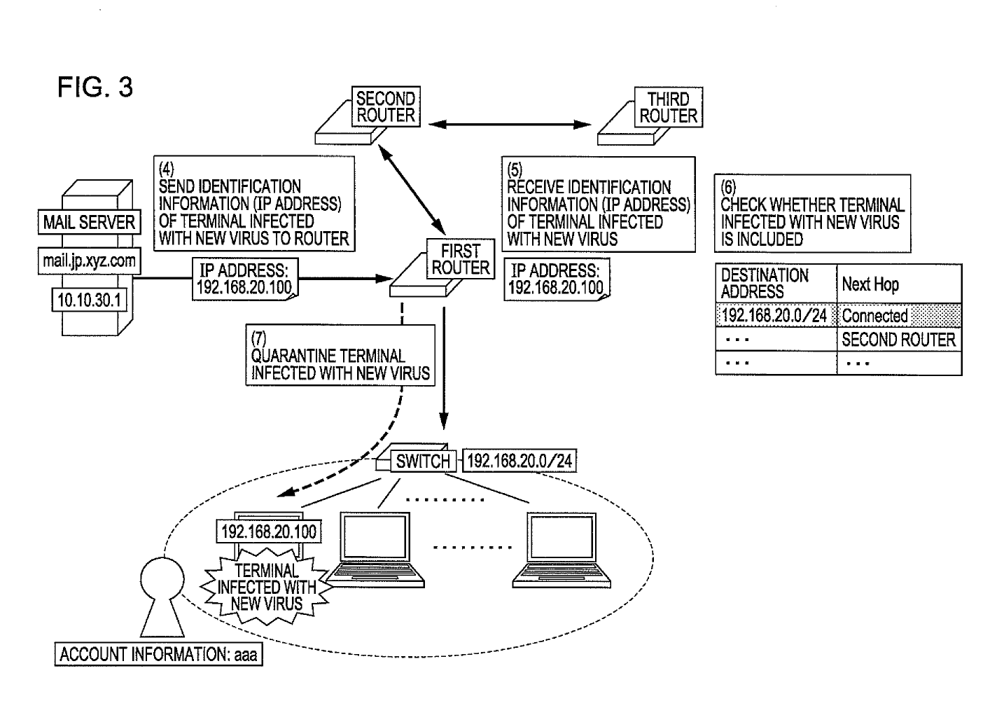

First, main features of a mail system according to the first embodiment will be described with reference to FIGS. 1 to 3. FIG. 1 is a diagram for explaining an overview of the mail system according to the first embodiment. FIGS. 2 and 3 are operation flow diagrams for explaining features of the mail system according to the first embodiment.

The mail system 106 according to the first embodiment includes a main server, and one or more routers that relay exchange of e-mails between the mail server and terminals. The mail server stores information of e-mails. The mail server distributes e-mails addressed to a terminal in response to a distribution request from the terminal. The mail server stores a distribution request history. The distribution request history contains each distribution request corresponding to terminal identification information of the terminal that issued the distribution request. The “router” corresponds to a “relaying device” in claims.

More specifically, as shown in FIG. 1, a domain name of a mail server is “mail.jp.xyz.com” and an IP address of the mail server is “10.10.30.1”. The mail server manages a domain with a domain name “jp.xyz.com”. The mail server stores information of both e-mails received via the Internet and e-mails that are received from terminals in a network within the mail server and sent outside the mail system in “mail archive information”. For example, as shown in FIG. 1, a message ID “AAAAAAAA.11111111@jp.xyz.com” is assigned for unique identification of an e-mail, a time of reception of the e-mail by the mail server is “November 24, 2006 (Fri.), 15:40:09”, a source mail address is “xxx@yyy.com”, a destination mail address is “aaa@jp.xyz.com”, and the mail server stores the message ID, the time of the e-mail, the source mail address, the destination mail address and so forth in association with a body of the e-mail and an attached file attached to the e-mail.

Furthermore, as shown in FIG. 1, for example, an IP address of a terminal is “192.168.20.100”, account information of a client user who uses the terminal is “aaa”, and in response to a distribution request from the terminal, the mail server distributes the e-mail to the terminal having address “aaa@jp.xyz.com”.

At that time, as shown in FIG. 1, the mail server stores “aaa@jp.xyz.com” in association with the IP address “192.168.20.100” in a “distribution request history”. The IP address serves as terminal identification information for identifying the terminal. The mail server also stores a distribution request time “November 24, 2006 (Fri.), 15:42:12” representing a time of reception of the distribution request from the terminal.

Then, the mail server checks the received e-mail on the basis of a “virus definition file” including a collection of features of viruses. More specifically, as shown in FIG. 1, the mail server compares contents of the received e-mail with each virus pattern (virus pattern 1, virus pattern 2, etc.) included in the virus definition file, and determines that a virus is attached to the e-mail when a matching pattern is detected.

Furthermore, as shown in FIG. 1, a plurality of routers is provided between the mail server and the terminal. For example, a first router manages terminals included in a subnetwork with an IP address “192.168.20.0/24”. And the first router relays exchange of e-mails between the mail server and the terminal via switches of the first router.

Main features of the mail system according to the first embodiment are both that a terminal which requested distribution of an e-mail having a virus attached is identified at the mail server, and that the terminal identified by the mail server is disconnected from the network at the relaying device.

This mail feature will now be described briefly. When definitions of new viruses have been added to the virus definition file, the mail server in the mail system according to the first embodiment checks the mail archive information to identify an e-mail having a new virus attached to the e-mail.

As shown in FIG. 2, when definitions of new viruses (virus pattern N1, virus pattern N2, etc.) have been added to the virus definition file of the mail server, for example, by a security company via the Internet, the mail server checks the mail archive information to identify an e-mail having any of the new viruses attached to the e-mail (see (1) in FIG. 2). For example, as shown in FIG. 2, the e-mail has the message ID “AAAAAAAA.11111111@jp.xyz.com,” the reception time of the e-mail “November 24, 2006 (Fri.), 15:40:09,” the source mail address of the e-mail “xxx@yyy.com,” and the destination mail address of the e-mail “aaa.jp.xyz.com.” The mail server checks the mail archive information, the mail server identifies that a new virus (e.g., the virus pattern N1) is attached to the e-mail. The new virus which is attached to the e-mail means a new virus that had not been included in the virus definition file at the time of reception of the e-mail by the mail server.

Then, the mail server in the mail system according to the first embodiment obtains account information associated with the identified e-mail having the new virus attached. That is, the mail server obtains the account information “aaa” from the identified e-mail having the new virus attached (see (2) in FIG. 2).

Then, with reference to both the obtained account information and the distribution request history, the mail server in the mail system according to the first embodiment extracts an IP address of a terminal that requested distribution of the e-mail having the new virus attached as identification information of a terminal that is infected with the new virus. For example, with reference to the distribution request history, the mail server extracts identification information of the terminal which is infected with the new virus indicating that the IP address of the terminal that requested distribution using the account information “aaa” is “192.168.20.100” (see (3) in FIG. 2).

Then, the mail server in the mail system according to the first embodiment sends the identification information of the new-virus-infected terminal to the router. That is, the mail server sends a request for quaranting the terminal with the IP address “192.168.20.100” (see (4) in FIG. 3). In this embodiment, the mail server transfers the identification information of the new-virus-infected terminal to a second router and a third router via the first router.

Then, in the mail system according to the first embodiment, the mail server transmits the identification information of the new-virus-infected terminal to the first router, and the first router receives the identification information. That is, the first router receives the IP address “192.168.20.100” from the mail server as the identification information of the new-virus-infected terminal (see (5) in FIG. 3).

Then, the router in the mail system according to the first embodiment checks whether the new-virus-infected terminal corresponding to the identification information transmitted from the mail server is a terminal that is included in the network segment that the router is in charge of. For example, when the first router receives the IP address “192.168.20.100”, since the next hop for the destination address “192.168.20.0124” is “connected” according to a routing table shown in FIG. 3, the first router determines that the terminal with the IP address “192.168.20.100” is a terminal in the network segment that the first router is in charge of (see (6) in FIG. 3).

Then, when the router in the mail system according to the first embodiment has determined that the new-virus-infected terminal is included in the terminals whose traffic is relayed by the first router itself, the router disconnects the new-virus-infected terminal from the network. That is, since the terminal with the IP address “192.168.20.100” is included in the terminals whose traffic is relayed by the first router, the first router disconnects the new-virus-infected terminal from the network (see (7) in FIG. 3). For example, the router prohibits the new-virus-infected terminal having the IP address “192.168.20.100” from exchanging packets, for example, by packet filtering.

When the router executes processing for prohibiting exchange of packets, the router may allow the terminal being quarantined (the terminal with the IP address “192.168.20.100”) to carry out communications for updating an operating system (OS) running on the terminal, for updating the “virus definition file”, and so forth. Furthermore, the router may cancel prohibition of packet exchange when the router is notified by the terminal of the completion of updating of the OS or updating of the “virus definition file”.

Configuration of the mail server in the first embodiment.

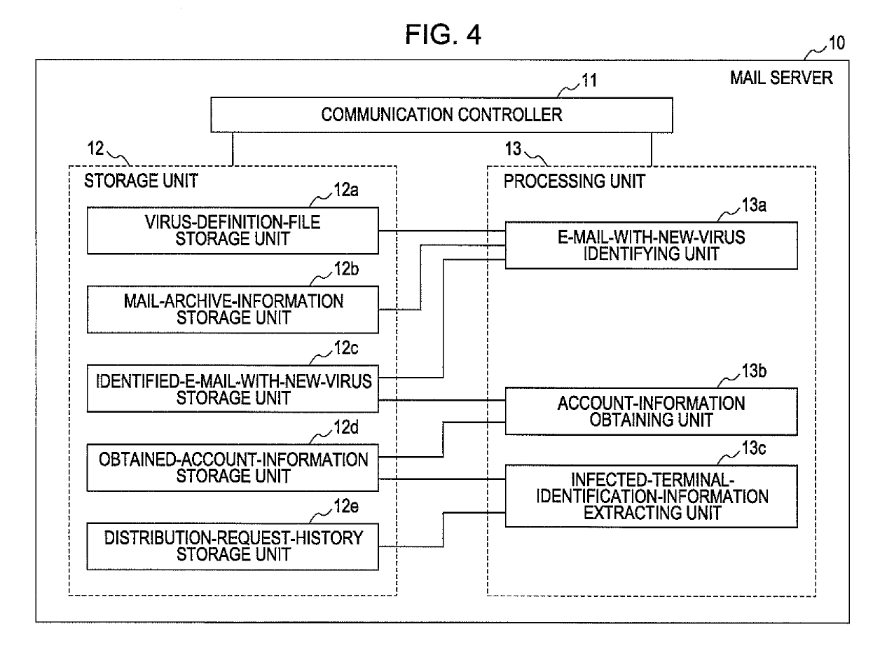

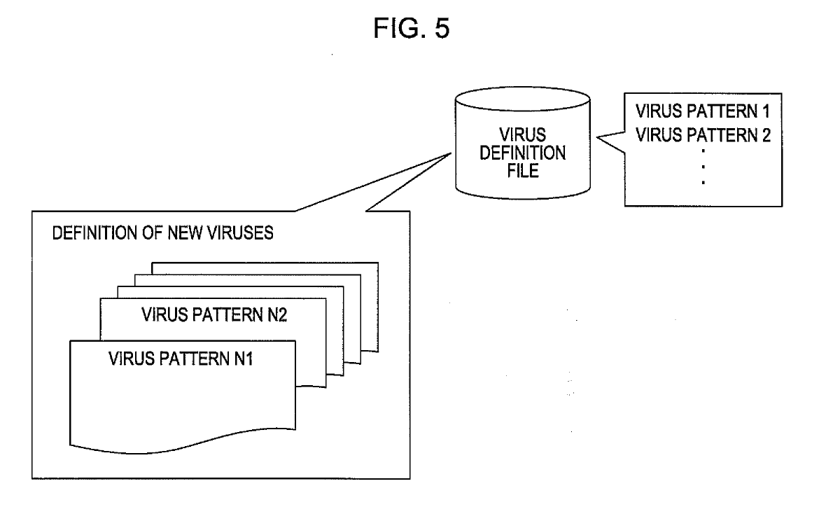

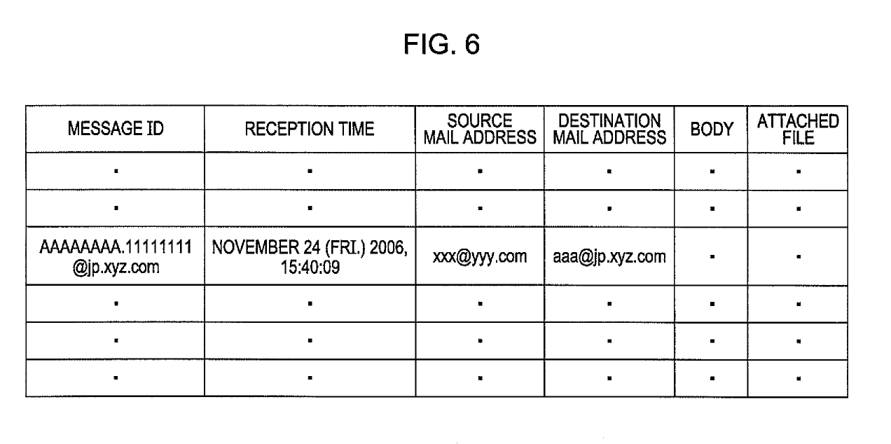

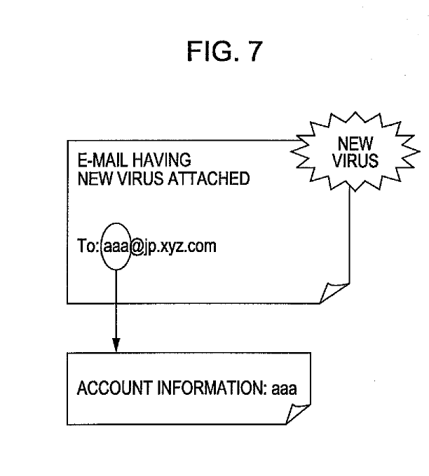

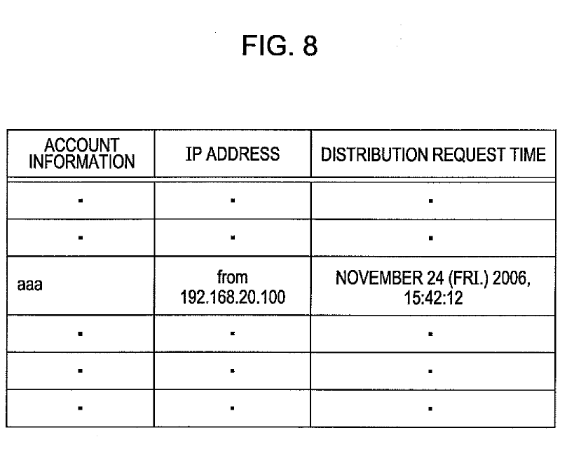

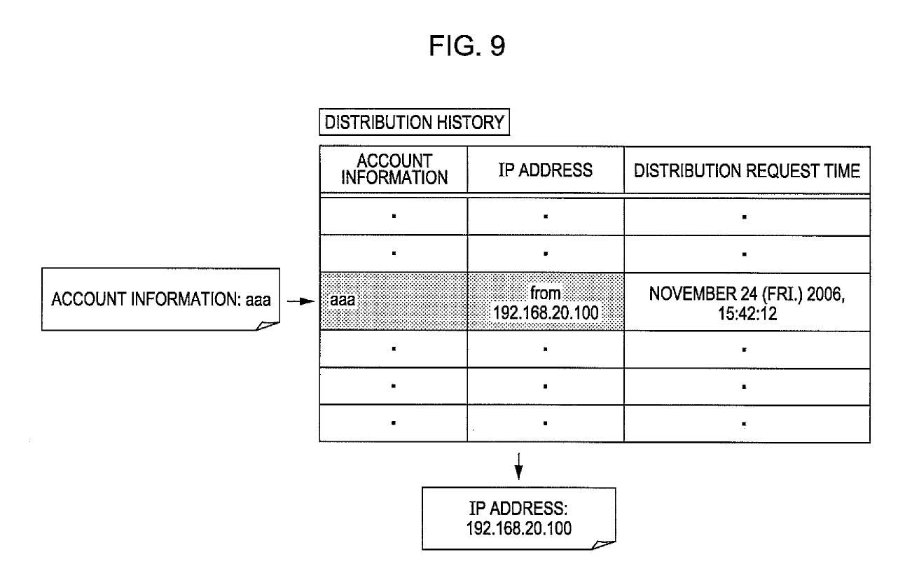

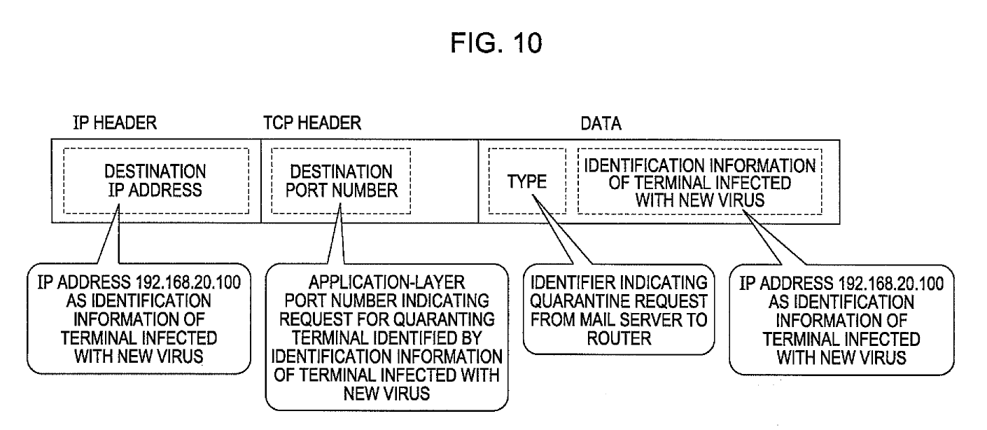

Next, the configuration of the mail server in the first embodiment will be described with reference to FIGS. 4 to 10. FIG. 4 is a block diagram showing the configuration of the mail server in the first embodiment. FIG. 5 is a diagram for explaining a virus-definition file storage unit of the mail server in the first embodiment. FIG. 6 is a diagram for explaining a mail-archive-information storage unit of the mail server in the first embodiment. FIG. 7 is a diagram for explaining an account-information obtaining unit of the mail server in the first embodiment. FIG. 8 is a diagram for explaining a distribution-request-history storage unit of the mail server in the first embodiment. FIG. 9 is a diagram for explaining an infected-terminal-identification-information extracting unit of the mail server in the first embodiment. FIG. 10 is a diagram for explaining terminal identification information sent from the mail server to a router in the first embodiment.

As shown in FIG. 4, a mail server 10 in the first embodiment includes a communication controller 11, a storage unit 12, and a processing unit 13.

The communication controller 11 controls transfer of data that is transmitted or received via a network. For example, the communication controller 11 sends and receives e-mails, receives definitions of new viruses, sends new-virus-infected-terminal identification information, and so forth according to communication protocols called SMTP/POP3. The communication controller 11 corresponds to an “infected-terminal-identification-information sending unit” in claims.

The storage unit 12 stores both data that is used for various types of processing executed by the processing unit 13, and results of various types of processing executed by the processing unit 13. As components particularly relating to features of the present invention, as shown in FIG. 4, the storage unit 12 includes a virus-definition-file storage unit 12a, a mail-archive-information storage unit 12b, an identified-e-mail-with-new-virus storage unit 12c, an obtained-account-information storage unit 12d, and a distribution-request-history storage unit 12e. The virus-definition-file storage unit 12a stores a virus definition file including a collection of features of viruses. The mail-archive-information storage unit 12b stores information of both e-mails received via the Internet and e-mails sent from terminals in a network within the mail system. The identified-e-mail-with-new-virus storage unit 12c stores information of an e-mail with a new virus. The information of the e-mail with the new virus is identified by an e-mail-with-new-virus identifying unit 13a which will be described later. The obtained-account-information storage unit 12d stores account information of the e-mail with the new virus. The account information of the e-mail with the new virus is obtained by an account-information obtaining unit 13b which will be described later. The distribution-request-history storage unit 12e stores a distribution request history in which each distribution request is associated with identification information of a terminal that issued the distribution request. These components will be described later in more detail.

The processing unit 13 executes various types of processing on the basis of both data transferred from the communication controller 11 and data stored in the storage unit 12. As components particularly relating to features of the present invention, as shown in FIG. 4, the processing unit 13 includes an e-mail-with-new-virus identifying unit 13a, an account-information obtaining unit 13b, and an infected-terminal-identification-information extracting unit 13c. The e-mail-with-new-virus identifying unit 13a executes an operation corresponding to an “e-mail-with-new-virus identifying” in claims. The account-information obtaining unit 13b executes “account-information obtaining” in claims. The infected-terminal-identification-information extracting unit 13c executes “infected-terminal-identification-information extracting”.

When definitions of new viruses have been added to the virus definition file, the e-mail-with-new-virus identifying unit 13a checks mail archive information. For example, as shown in FIG. 5, when definitions of new viruses (virus pattern N1, virus pattern N2, etc.) have been added to the virus definitions file (virus pattern 1, virus pattern 2, etc.) stored in the virus-definition-file storage unit 12a, the e-mail-with-new-virus identifying unit 13a checks the mail-archive-information storage unit 12b (see FIG. 6). The mail-archive-information storage unit 12b stores sets of a “message ID” assigned for unique identification of each e-mail, a “reception time” representing time of reception of the e-mail by the mail server, and both a “source mail address” and a “destination mail address” of the e-mail, in association with both a body of the e-mail and an attached file attached to the e-mail.

The e-mail-with-new-virus identifying unit 13a identifies an e-mail with a new virus, i.e., an e-mail having a new virus attached to the e-mail, and stores the result of identification in the identified-e-mail-with-new-virus storage unit 12c. The e-mail-with-new-virus identifying unit 13a checks the mail-archive-information storage unit 12b shown in FIG. 6 to identify that, for example, a new virus (e.g., the virus pattern N1) is attached to an e-mail with a message ID “AAAAAAAA.11111111@jp.xyz.com”, a reception time “November 24, 2006 (Fri.), 15:40:09”, a source mail address “xxx@yyy.com”, and a destination mail address “aaa@jp.xyz.com”.

The account-information obtaining unit 13b obtains account information from the information of the e-mail with the new virus. The information of the e-mail with the new virus is stored in the identified-e-mail-with-new-virus storage unit 12c. The account-information obtaining unit 13b stores the obtained account information in the obtained-account-information storage unit 12d. For example, as shown in FIG. 7, the account-information obtaining unit 13b obtains account information “aaa” from the identified e-mail with the new virus.

With reference to both the account information stored in the obtained-account-information storage unit 12d and the distribution request history stored in the distribution-request-history storage unit 12e , the infected-terminal-identification-information extracting unit 13c extracts an IP address of a terminal that requested distribution of the e-mail with the new virus, as new-virus-infected-terminal identification information. Values of account information, an IP address, and distribution request time are associated with each other as shown in FIG. 8 in the distribution request history. With reference to the distribution-request-history storage unit 12e storing the distribution request history, the infected-terminal-identification-information extracting unit 13c extracts an IP address associated with the account information stored in the obtained-account-information storage unit 12d. For example, the infected-terminal-identification-information extracting unit 13c extracts new-virus-infected-terminal identification information indicating that the IP address of the terminal that requested distribution using the account information “aaa” is “192.168.20.100”.

The mail server 10 sends the extracted new-virus-infected-terminal identification information to a router 20 which will be described later. For example, the mail server 10 sends an IP packet configured as shown in FIG. 10 to the router 20. That is, as a destination IP address in an IP header, the mail server 10 sets an IP address “192.168.20.100” according to the new-virus-infected-terminal identification information. Furthermore, as a destination port number in a TCP header, the mail server 10 sets an application-layer port number indicating that the packet contains a message requesting that the terminal identified by the new-virus-infected-terminal identification information is quarantined. Furthermore, as a data type, the mail server 10 sets an identifier indicating that the packet includes a quarantine request from a mail server to a router. Furthermore, as data, the mail server 10 sets the IP address “192.168.20.100” according to the new-virus-infected-terminal identification information. In the IP packet, a UDP header may be used instead of the TCP header.

Configuration of the router in the first embodiment.

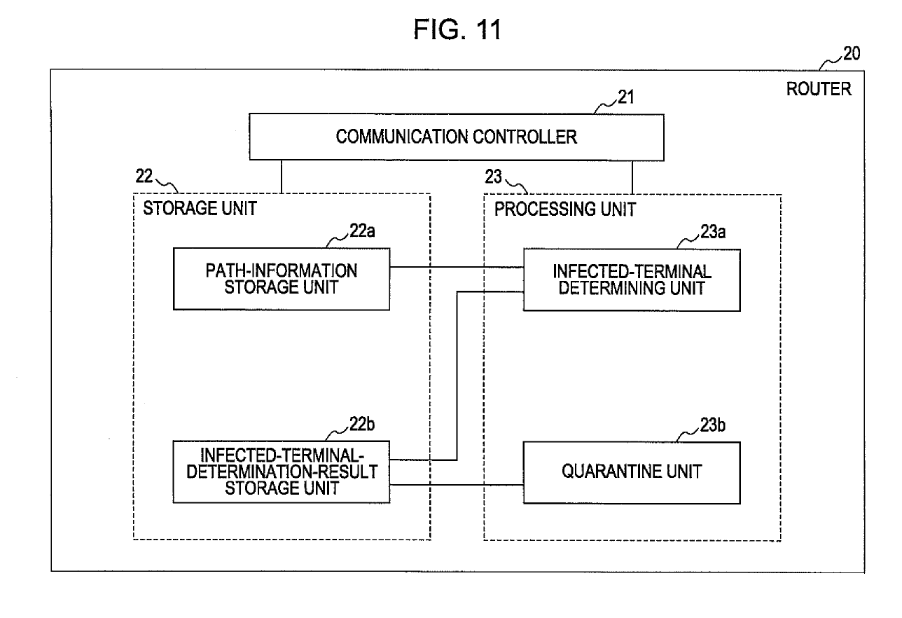

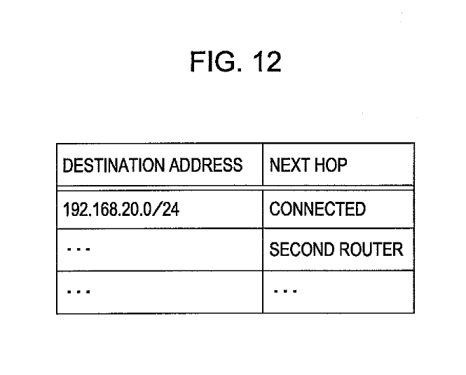

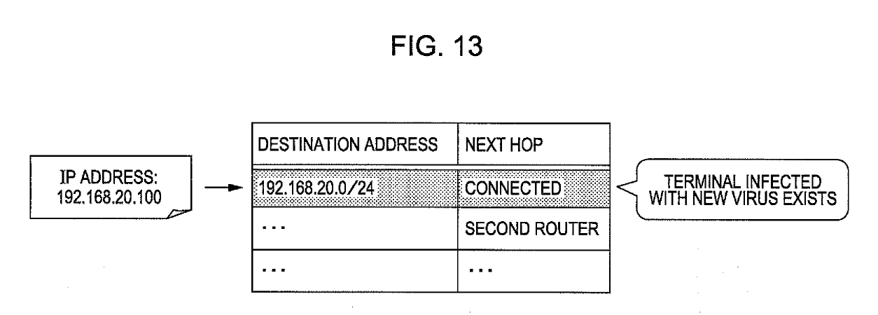

Next, the configuration of the router in the first embodiment will be described with reference to FIGS. 11 to 13. FIG. 11 is a block diagram showing the configuration of the router in the first embodiment. FIG. 12 is a diagram for explaining a path-information storage unit. FIG. 13 is a diagram for explaining an infected-terminal determining unit.

As shown in FIG. 11, the router 20 in the first embodiment includes a communication controller 21, a storage unit 22, and a processing unit 23.

The communication controller 21 controls data communications between the mail server 10 and terminals. More specifically, the communication controller 21 carries out communications for exchanging e-mails between the mail server 10 and terminals. The communication controller 21 receives the new-virus-infected-terminal identification information from the mail server 10. The communication controller 21 corresponds to an “infected-terminal-identification-information receiving unit” in claims.

For example, when the communication controller 21 receives an IP packet configured as shown in FIG. 10 from the mail server 10, on the basis of the data type field of the IP packet that contains the identifier indicating a quarantine request from a mail server to a router, the communication controller 21 relays the IP packet to an infected-terminal determining unit 23a, which will be described later, instead of sending the packet to a terminal having the destination IP address “192.168.20.100”.

The storage unit 22 stores data that is used for various types of processing executed by the processing unit 23. As components particularly relating to features of the present invention, as shown in FIG. 11, the storage unit 22 includes a path-information storage unit 22a and an infected-terminal-determination-result storage unit 22b. The path-information storage unit 22a stores a routing table of the router 20. The infected-terminal-determination-result storage unit 22b stores a result of determination by an infected-terminal determining unit 23a which will be described later. Corresponding to the new-virus-infected-terminal identification information, the result of determination is a result determined whether a terminal infected with a new virus is included in terminals whose traffic is relayed by the router 20. These components will be described later in detail.

The processing unit 23 executes various types of processing on the basis of both data transferred from the communication controller 21 and data stored in the storage unit 22. As components particularly relating to features of the present invention, as shown in FIG. 11, the processing unit 23 includes an infected-terminal determining unit 23a and a quarantine unit 23b. The infected-terminal determining unit 23a corresponds to an “infected-terminal determining unit” in claims. The quarantine unit 23b corresponds to a “quaranting unit” in claims.

A router 20 receives the new-virus-infected-terminal identification information from the mail server 10. With reference to the routing table stored in the path-information storage unit 22a, the infected-terminal determining unit 23a determines whether the new-virus-infected terminal corresponding to the new-virus-infected-terminal identification information is included in terminals whose traffic is relayed by the router 20. Then, the infected-terminal determining unit 23a stores the result in the infected-terminal-determination-result storage unit 22b. More specifically, as shown in FIG. 12, the path-information storage unit 22a stores the routing table in which values of “destination address” and “next hop” are associated with each other. With reference to the path-information storage unit 22a, the infected-terminal determining unit 23a determines whether the terminal having the IP address “192.168.20.100” which is represented by the new-virus-infected-terminal identification information is included in the terminals whose traffic is relayed by the router 20. For example, as shown in FIG. 13, since the next hop for the destination address “192.168.20.0/24” is “connected”, the infected-terminal determining unit 23a determines that the terminal having the IP address “1192.168.20.100” is included in the terminals whose traffic is relayed by the router 20.

On the other hand, when the infected-terminal determining unit 23a determines that the new-virus-infected terminal corresponding to the new-virus-infected-terminal identification information is not included in the terminals whose traffic is related by the router 20, the infected-terminal determining unit 23a sends the terminal-infected-with-new-virus identification information to another router. For example, with reference to a routing table shown in FIG. 12, the infected-terminal determining unit 23a sends the terminal-infected-with-new-virus identification information to the second router.

As shown in FIG. 3, the router 20 receives the terminal-infected-with-new-virus identification information (IP address) from the mail server, the IP address “10.10.30.1” is assigned to the mail server, the IP address “192.168.20.0/24” is assigned to the sub-network that the router 20 is in charge of. The configuration definition information in the router 20 may be defined in advance as below.

The router 20 reports the terminal-infected-with-new-virus identification information to the infected-terminal determining unit 23a when the terminal-infected-with-new-virus identification information is an IP address of a terminal that is included in the sub-network, while otherwise the router 20 reports sends the IP address to the second router when the terminal-infected-with-new-virus identification information is not an IP address of a terminal that is included in the sub-network.

On the basis of the result of determination stored in the infected-terminal-determination-result storage unit 22b, when the new-virus-infected terminal is included in the terminals whose traffic is relayed by the router 20, the quarantine unit 23b quarantines the new-virus-infected terminal from the network (see (7) in FIG. 3). For example, since the terminal having the IP address “192.168.20.100” is included in the terminals whose traffic is relayed by the router 20, the quarantine unit 23b quarantines the new-virus-infected terminal from the network. The quarantine unit 23b executes quarantine processing, for example, by blocking packets the new-virus-infected terminal having the IP address “192.168.20.100” sends and receives, for example, by performing packet filtering processing.

At that time when the terminal is quarantined (the terminal having the IP address “192.168.20.100”), the quarantine unit 23b may allow the terminal to carry out only communications for updating an OS running on the terminal, for updating the virus definition file, and so forth. Furthermore, the router 20 may cancel blocking that the terminal sends and receives packets when the terminal notifies the router that the updating of the OS or the updating of the virus definition file has been completed.

Procedure of processing executed by the mail server in the first embodiment.

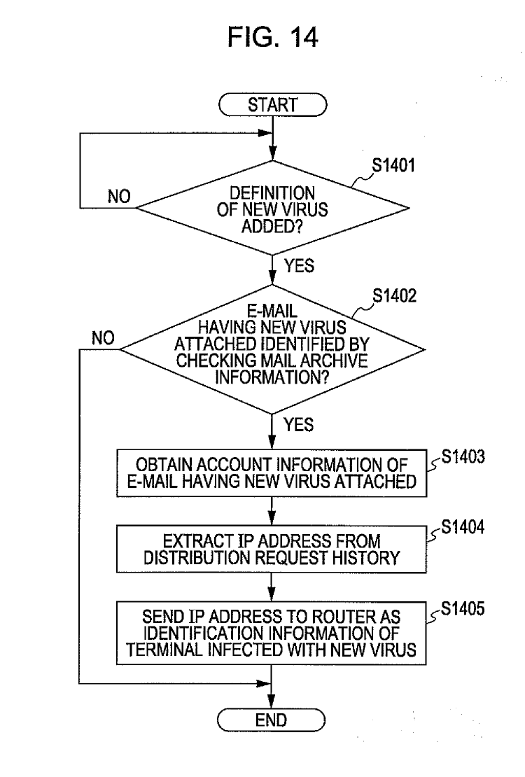

Next, processing executed by the mail server 10 in the first embodiment will be described with reference to FIG. 14. FIG. 14 is a flow chart for explaining a procedure of processing executed by the mail server 10 in the first embodiment.

First, at the mail server 10 in the first embodiment, when definitions of new viruses have been added to the virus definition file stored in the virus-definition-file storage unit 12a (Yes in operation S1401), the e-mail-with-new-virus identifying unit 13a checks the mail archive information stored in the mail-archive-information storage unit 12b (operation S1402). When the e-mail-with-new-virus identifying unit 13a does not detect any e-mail with a new virus, i.e., any e-mail having a new virus attached to the e-mail (No in operation S1402), the mail server 10 exits the procedure of FIG. 14.

On the other hand, when an e-mail with new virus, i.e., an e-mail having a new virus attached to the e-mail, is detected by the e-mail-with-new-virus identifying unit 13a (Yes in operation S1402), information of the e-mail with the new virus is stored in the identified-e-mail-with-new-virus storage unit 12c, and the account-information obtaining unit 13b obtains account information from the information of the e-mail with the new virus (operation S1403). For example, as shown in FIG. 7, the account-information obtaining unit 13b obtains account information “aaa” from the identified e-mail with the new virus.

Then, with reference to both the obtained account information and the distribution request history stored in the distribution-request-history storage unit 12e, the infected-terminal-identification-information extracting unit 13c extracts an IP address of a terminal that requested distribution of the e-mail with the new virus, as new-virus-infected-terminal identification information (operation S1404). For example, the infected-terminal-identification-information extracting unit 13c extracts new-virus-infected-terminal identification information indicating that the IP address of the terminal which requested distribution using the account information “aaa” is “192.168.20.100”, as shown in FIG. 9.

Then, the mail server 10 sends the IP address to the router 20 as the new-virus-infected-terminal identification information (operation S1405), and then exits the procedure of FIG. 14. For example, the mail server 10 sends an IP packet configured as shown in FIG. 10 to the router 20.

When an e-mail with a new virus, i.e., an e-mail having a new virus attached to the e-mail, is identified by the infected-terminal-identification-information extracting unit 13c (Yes in operation S1402), information of the e-mail with the new virus may be deleted from the mail archive information stored in the mail-archive-information storage unit 12b. However, according to the present invention, the information need not necessarily be deleted.

Procedure of processing executed by the router in the first embodiment.

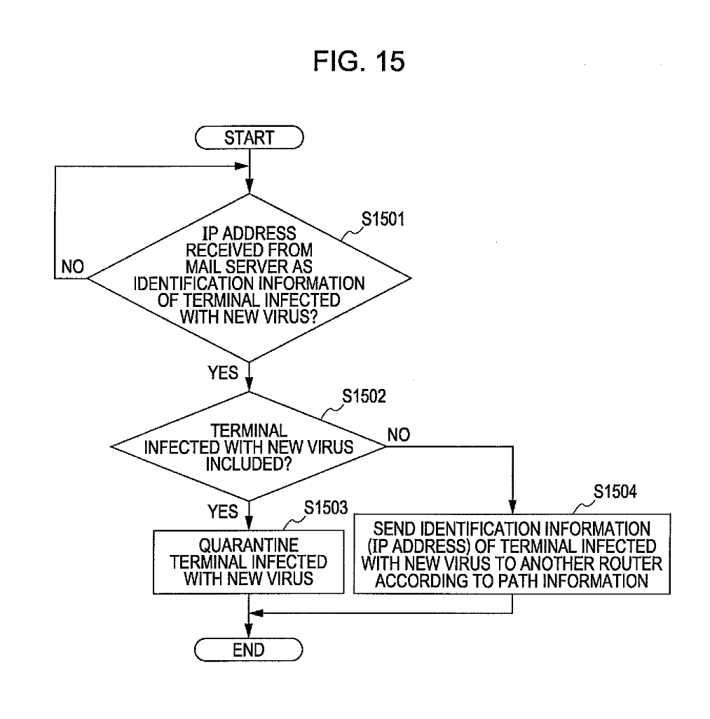

Next, processing which is executed by the router 20 in the first embodiment will be described with reference to FIG. 15. FIG. 15 is a flow chart for explaining a procedure of processing executed by the router in the first embodiment.

First, when the router 20 receives an IP address from the mail server 10 as new-virus-infected-terminal identification information (Yes in operation S1501), the infected-terminal determining unit 23a of the router 20 determines whether the new-virus-infected terminal corresponding to the new-virus-infected-terminal identification information is included in terminals whose traffic is relayed by the router 20 (operation S1502). When the infected-terminal determining unit 23a has determined that the new-virus-infected terminal is not included in the terminals whose traffic is relayed by the router 20 (No in operation S1502), the infected-terminal determining unit 23a sends the new-virus-infected-terminal identification information to another router (operation S1504). For example, with reference to a routing table shown in FIG. 12, the infected-terminal determining unit 23a sends the new-virus-infected-terminal identification information to the second router.

On the other hand, when the infected-terminal determining unit 23a has determined that the new-virus-infected terminal is included in the terminals whose traffic is relayed by the router 20 (Yes in operation S1502), the quarantine unit 23b quarantines the new-virus-infected terminal from the network (operation S1503), and then exits the procedure of FIG. 15. For example, when the infected-terminal determining unit 23a of the router 20 determines that the terminal having the IP address “192.168.20.100” is included in the terminals whose traffic is relayed by the router 20 since the next hop for the destination address “192.168.20.0/24” is “connected” as shown in FIG. 13, the quarantine unit 23b quarantines the terminal having the IP address “192.168.20.100” from the network. The quarantine unit 23b executes quarantine processing, for example, blocking packets the new-virus-infected terminal having the IP address “192.168.20.100” sends and receives, for example, by performing packet filtering processing.

At that time, the quarantine unit 23b may allow the terminal being quarantined (the terminal with the IP address “192.168.20.100”) to carry out only communications for updating an OS running on the terminal, for updating the virus definition file, and so forth. Furthermore, the router 20 may cancel blocking that the terminal sends and receives packets when the terminal notifies the router by that the updating of the OS or the updating of the virus definition file has been completed.

### Second Embodiment

The first embodiment described above relates to a case where only one mail server is provided. In a second embodiment described below, a mail server is connected to other mail servers, and one of these mail servers functions as a mail gateway.

Overview and features of a mail system according to the second embodiment.

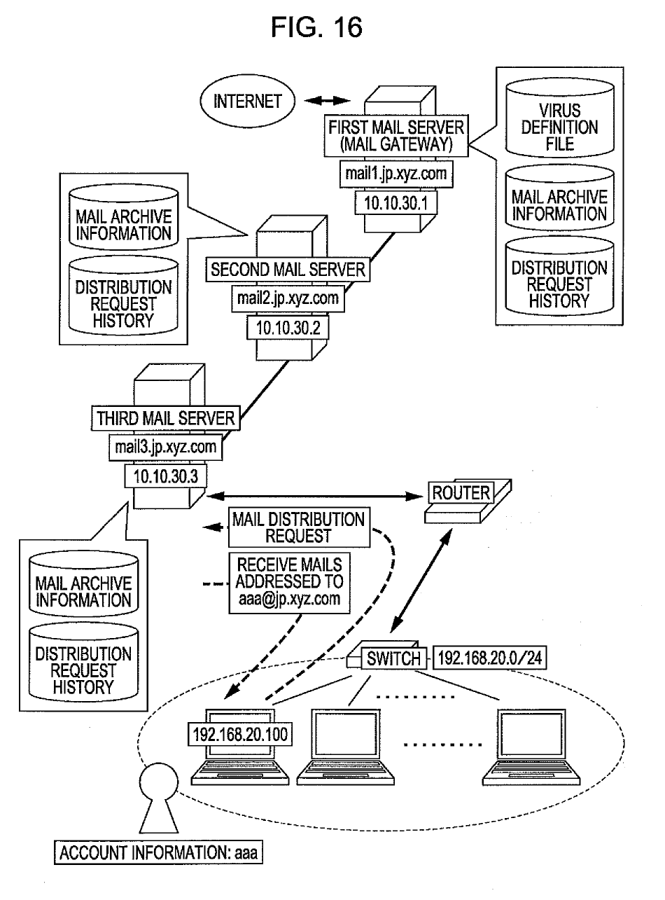

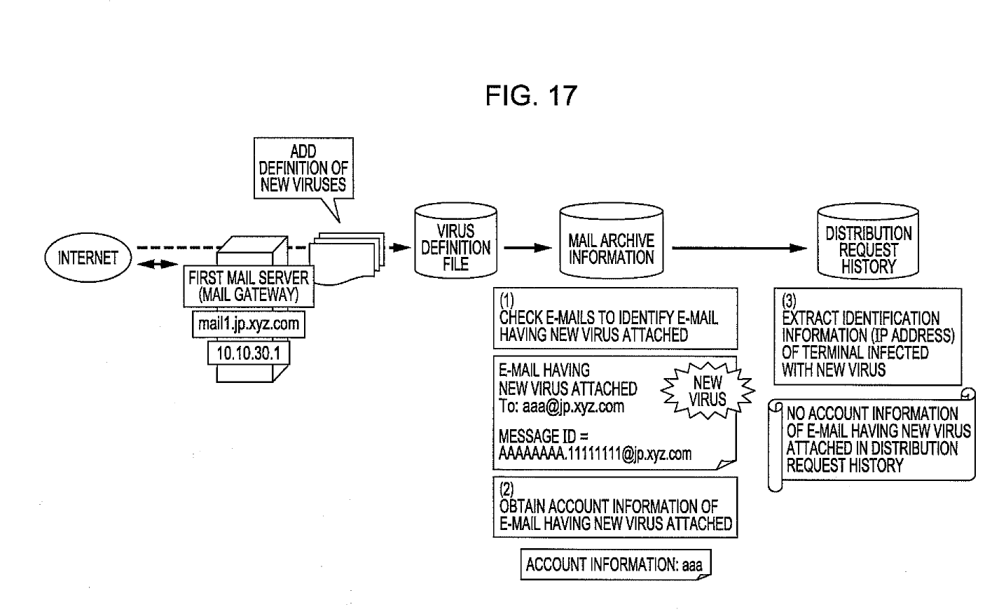

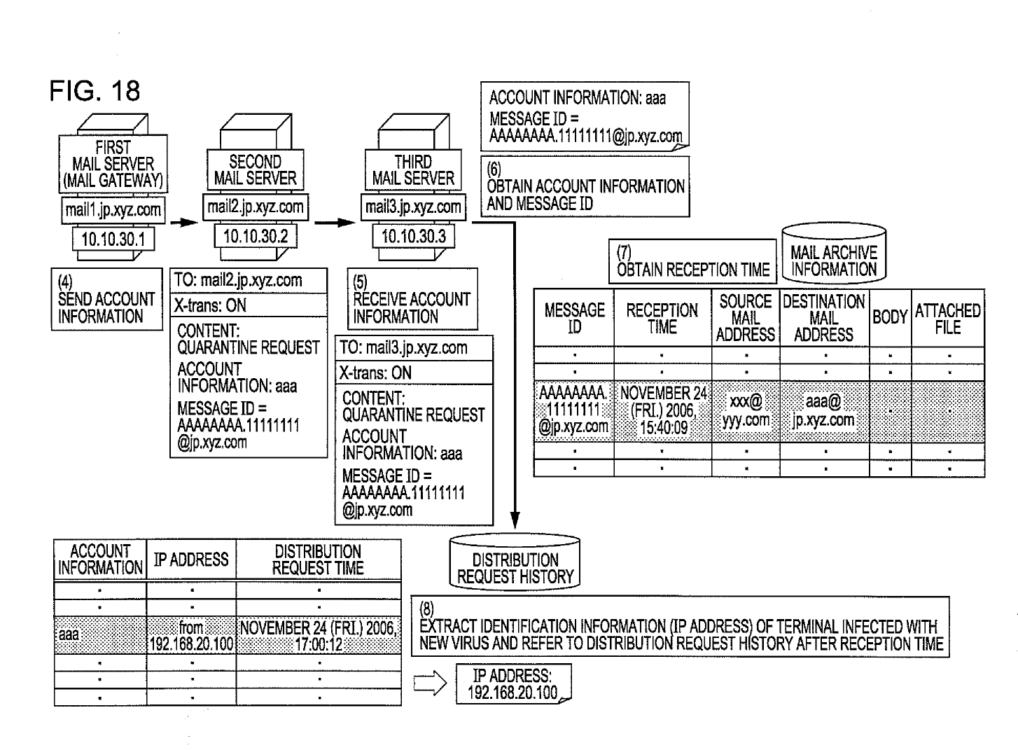

First, main features of a mail system according to the second embodiment will be described with reference to FIGS. 16 to 18. FIG. 16 is a diagram for explaining an overview of the mail system according to the second embodiment. FIGS. 17 and 18 are operation flow diagrams for explaining features of the mail system according to the second embodiment.

The mail system according to the second embodiment includes a mail gateway, a plurality of mail servers, and a router. For example, as shown in FIG. 16, a first mail server, which functions as a mail gateway, is connected to a second mail server, and the second mail server is connected to a third mail server.

As shown in FIG. 16, the first mail server (mail1.jp.xyz.com, an IP address “10.10.30.1”) manages a domain whose name “jp.xyz.com,” and functions as a mail gateway. Similarly to the mail server in the first embodiment, the first mail server stores information of e-mails in “mail archive information.” The first mail server distributes e-mails which are addressed to a terminal in response to a distribution request from the terminal. The first mail server stores a “distribution request history” in which each distribution request is associated with terminal identification information of a terminal that issued the distribution request. And the first mail server checks e-mails which are already received on the basis of a “virus definition file.”

Furthermore, similarly to the mail server in the first embodiment, each of the mail servers other than the mail gateway (the second mail server and the third mail server shown in FIG. 16) stores information of e-mails in “mail archive information.” Each of the mail servers other than the mail gateway distributes e-mails addressed to a terminal in response to a distribution request from the terminal. And each of the mail servers other than the mail gateway stores a “distribution request history” in which each distribution request is associated with terminal identification information of the terminal that issued the distribution request. However, for example, the mail servers other than the mail gateway might not hold a virus definition file, and do not check e-mails which are already received.

For example, in the mail archive information, the third mail server (mail3.jp.xyz.com, an IP address “10.10.30.3”) shown in FIG. 16 stores both information of e-mails received from the mail gateway via the second mail server and information of e-mails that are both received from terminals in a network within the mail system and sent outside the mail system. Furthermore, in response to a distribution request from a terminal (an IP address “192.168.20.100”) which a client user (account information “aaa”) uses, the third mail server distributes e-mails addressed to the terminal for “aaa@jp.xyz.com”. And the third mail server stores the account information “aaa” and the IP address “192.168.20.100” as terminal identification information of the terminal, in association with each other in the distribution request history. The third mail server also stores a distribution request time representing a time of reception of the distribution request from the terminal.

Furthermore, a router is provided between the mail server and the terminal. For example, the router shown in FIG. 11 manages traffic of terminals included in a sub-network having an IP address “192.168.20.0/24.” The router relays exchange of e-mails between the mail servers and the terminals via a switch.

First, when definitions of new viruses have been added to the virus definition file, the mail gateway in the mail system according to the second embodiment checks the mail archive information to identify an e-mail with a new virus, i.e., an e-mail having a new virus attached to the e-mail. More specifically, as shown in FIG. 17, when definitions of new viruses have been added to the virus definition file, for example, by a security company via the Internet, the mail gateway checks the mail archive information to identify an e-mail with new virus, i.e., an e-mail having a new virus attached to the e-mail. For example, the mail gateway identifies that a new virus is attached to an e-mail which is addressed to “aaa@jp.xyz.com” (a message ID of the e-mail is “AAAAAAAA.11111111@jp.xyz.com”) (see (1) in FIG. 17).

Then, the mail gateway in the mail system according to the second embodiment obtains account information of the identified e-mail with the new virus. For example, the mail gateway obtains account information “aaa” from the identified e-mail with the new virus (see (2) in FIG. 17).

Then, with reference to the distribution history request, when the obtained account information is not included in the distribution request history, the mail gateway in the mail system according to the second embodiment reports the account information to the other mail servers. That is, since no distribution request from a terminal having the account information “aaa” is included in the distribution request history of the mail gateway (see (3) in FIG. 17), the mail gateway reports the account information “aaa” to the second mail server and the third mail server (see (4) in FIG. 18). For example, the mail gateway reports the account information “aaa” to the second mail server (mail2.jp.xyz.com) and the third mail server (mail3.jp.xyz.com) in the form of an e-mail configured as shown in FIG. 18. In this embodiment, the mail gateway also reports the message ID “AAAAAAAA.11111111@jp.xyz.com” to the second mail server and the third mail server. In an extension header of the e-mail shown in FIG. 18, the mail gateway sets “X-trans:ON” to indicate that the e-mail is a terminal quarantine request.

Upon receiving the account information from the mail gateway, each of the mail servers in the mail system according to the second embodiment obtains the reception time of the e-mail with the new virus with reference to the mail archive information. For example, when the third mail server receives an e-mail addressed to “mail3.jp.xyz.com,” shown in FIG. 18, from the mail gateway via the second mail server (see (5) in FIG. 18), the third mail server obtains the account information “aaa” and the message ID “AAAAAAAA.11111111@jp.xyz.com” (see (6) in FIG. 18). Furthermore, with reference to the mail archive information, the third mail server obtains the reception time “November 24, 2006 (Fri.), 15:40:09” indicating the time of reception of the e-mail addressed to the terminal having the account information “aaa” (having the message ID “AAAAAAAA.11111111@jp.xyz.com”) received from the mail gateway via the second mail server (see (7) in FIG. 18). Alternatively, the third mail server may obtain the reception time of the e-mail with reference to an SMTP reception log.

Then, each of the mail servers in the mail system according to the second embodiment extracts an IP address that serves as new-virus-infected-terminal identification information, with reference to the distribution request history using the obtained account information and the reception time of the e-mail with the new virus. For example, when the third mail server receives a distribution request from the terminal having the account information “aaa” (having a distribution request time “November 24, 2006 (Fri.), 17:00:12”), the third mail server refers to the distribution request history on and after “November 24, 2006 (Fri.), 15:40:09” in the distribution request history shown in FIG. 18. The third mail server extracts new-virus-infected-terminal identification information indicating that the IP address of the terminal that received the e-mail with the new virus is “192.168.20.100” (see (8) in FIG. 18).

Then, similarly to the first embodiment, each of the mail servers in the mail system according to the second embodiment sends the extracted new-virus-infected-terminal identification information to the router (see (4) in FIG. 3). Similarly to the first embodiment, when the new-virus-infected terminal is included in terminals whose traffic is relayed by the router, the router in the mail system according to the second embodiment quarantines the new-virus-infected terminal from the network (see (7) in FIG. 3).

Configuration of the mail gateway in the second embodiment.

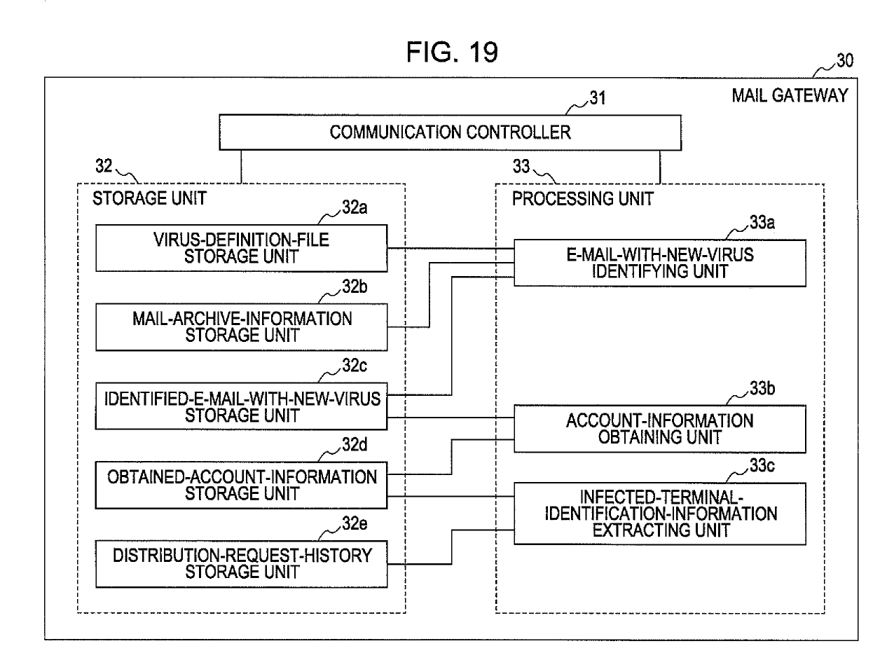

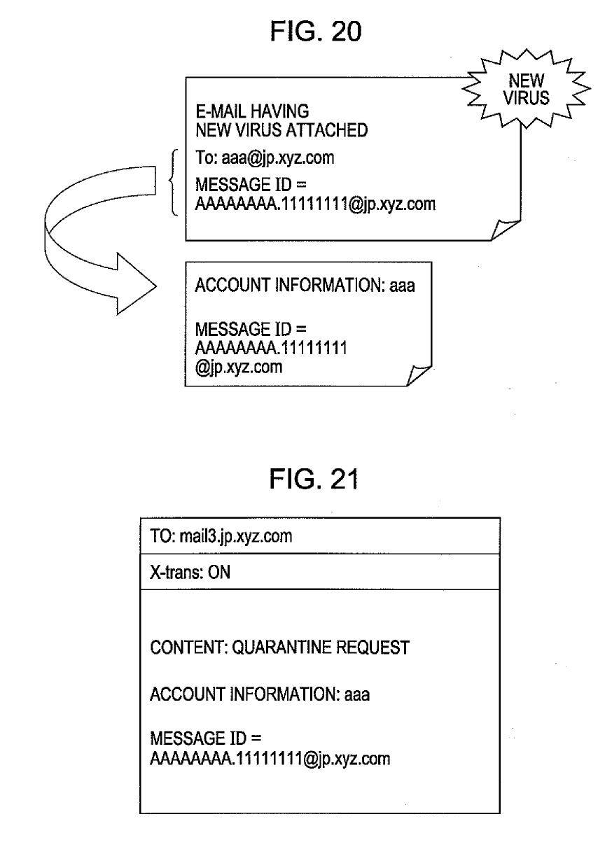

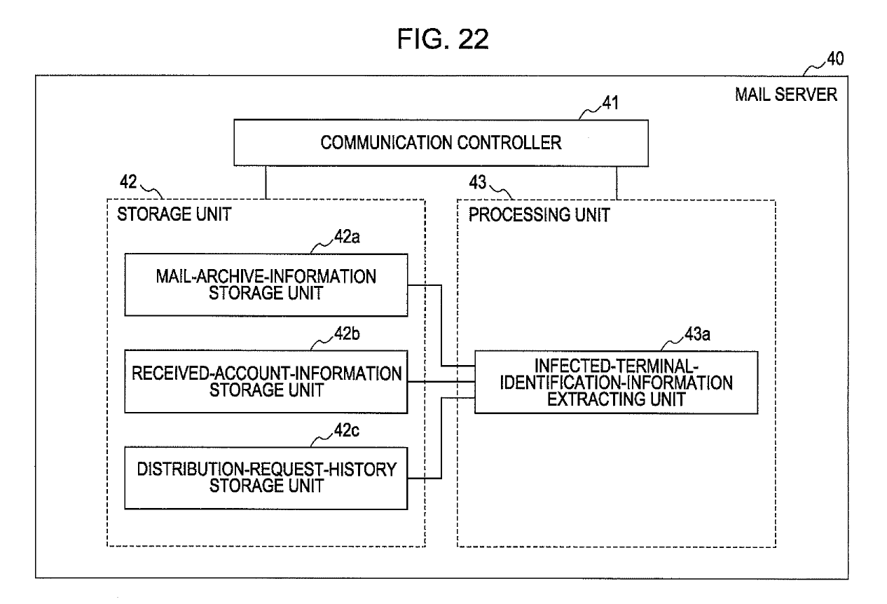

Next, the configuration of the mail gateway in the second embodiment will be described with reference to FIGS. 19 to 21. FIG. 19 is a block diagram showing the configuration of the mail gateway in the second embodiment. FIG. 20 is a diagram for explaining an account-information obtaining unit of the mail gateway in the second embodiment. FIG. 21 is a diagram for explaining account information sent from the mail gateway to a mail server in the second embodiment.

As shown in FIG. 19, a mail gateway 30 in the second embodiment includes a communication controller 31, a storage unit 32, and a processing unit 33.

The communication controller 31 controls transfer of data that is transmitted or received via a network. More specifically, the communication controller 31 sends and receives e-mails, receives definitions of new viruses, sends account information, sends new-virus-infected-terminal identification information, and so forth according to communication protocols called SMTP/POP3. The communication controller 31 executes processing corresponding to an “account-information sending” in claims, and also corresponds to an “infected-terminal-identification-information sending unit” in claims.

The storage unit 32 stores both data used for various types of processing executed by the processing unit 33 and results of various types of processing executed by the processing unit 33. As components particularly relating to features of the present invention, as shown in FIG. 19, the storage unit 32 includes a virus-definition-file storage unit 32a, a mail-archive-information storage unit 32b, an identified-e-mail-with-new-virus storage unit 32c, an obtained-account-information storage unit 32d, and a distribution-request-history storage unit 32e. The virus-definition-file storage unit 32a stores a virus definition file including a collection of features of viruses. The mail-archive-information storage unit 32b stores information of both e-mails received via the Internet and e-mails which are both received from terminals in a network within the mail system and sent outside the mail system. The identified-e-mail-with-new-virus storage unit 32c stores information of an e-mail with a new virus. The information is identified by an e-mail-with-new-virus identifying unit 33a which will be described later. The obtained-account-information storage unit 32d stores account information of an e-mail with a new virus. The account information is obtained by an account-information obtaining unit 33b which will be described later. The distribution-request-history storage unit 32e stores a distribution request history in which each distribution request is associated with identification information of a terminal that issued the distribution request.

The processing unit 33 executes various types of processing on the basis of both data transferred from the communication controller 31 and data stored in the storage unit 32. As components particularly relating to features of the present invention, as shown in FIG. 19, the processing unit 33 includes an e-mail-with-new-virus identifying unit 33a, an account-information obtaining unit 33b, and an infected-terminal-identification-information extracting unit 33c. The e-mail-with-new-virus identifying unit 33a executes processing corresponding to an “e-mail-with-new-virus identifying” in claims. The account-information obtaining unit 33b executes processing corresponding to an “account-information obtaining” in claims. The infected-terminal-identification-information extracting unit 33c executes processing corresponding to an “infected-terminal-identification-information extracting” in claims.

Similarly to the e-mail-with-new-virus identifying unit 13a in the first embodiment, the e-mail-with-new-virus identifying unit 33a checks mail archive information when definitions of new viruses have been added to the virus definition file. For example, as shown in FIG. 5, when definitions of new viruses (virus pattern N1, virus pattern N2, etc.) have been added to virus definitions (virus pattern 1, virus pattern 2, etc.) stored in the virus-definition-file storage unit 32a, the e-mail-with-new-virus identifying unit 33a checks the mail archive information in the mail-archive-information storage unit 32b. The mail-archive-information storage unit 32b stores sets of a “message ID” assigned for unique identification of an e-mail, a “reception time” representing time of reception of the e-mail by the mail server, and a “source mail address” and a “destination mail address” of the e-mail, in association with a “body” of the e-mail and an “attached file” attached to the e-mail.

Similarly to the e-mail-with-new-virus identifying unit 13a in the first embodiment, the e-mail-with-new-virus identifying unit 33a identifies an e-mail with a new virus, i.e., an e-mail having a new virus attached to the e-mail. The e-mail-with-new-virus identifying unit 33a stores the identified e-mail with the new virus in the identified-e-mail-with-new-virus storage unit 32c. More specifically, the e-mail-with-new-virus identifying unit 33a checks the mail archive information in the mail-archive-information storage unit 32b. And the e-mail-with-new-virus identifying unit 33a identifies that, for example, a new virus is attached to an e-mail addressed to “aaa@jp.xyz.com” (a message ID of the e-mail is “AAAAAAAA.11111111@jp.xyz.com”) (see (1) in FIG. 17).

Similarly to the account-information obtaining unit 13b in the first embodiment, the account-information obtaining unit 33b obtains account information from the information of the e-mail with the new virus. The information of the e-mail with the new virus is stored in the identified-e-mail-with-new-virus storage unit 32c. The account-information obtaining unit 33b stores the obtained account information in the obtained-account-information storage unit 32d. For example, as shown in FIG. 20, the account-information obtaining unit 33b obtains account information “aaa” together with the message ID “AAAAAAAA.11111111@jp.xyz.com” from the identified e-mail with the new virus.

Similarly to the infected-terminal-identification-information extracting unit 13c in the first embodiment, with reference to the account information stored in the obtained-account-information storage unit 32d and the distribution request history stored in the distribution-request-history storage unit 32e , when the account information is included in the distribution request history, the infected-terminal-identification-information extracting unit 33c extracts an IP address of a terminal that requested distribution of the e-mail with the new virus, as new-virus-infected-terminal identification information. When the account information is not included in the distribution request history, the infected-terminal-identification-information extracting unit 33c reports the account information to a plurality of mail servers via the communication controller 31. That is, when no distribution request from the terminal having the account information “aaa” is included in the distribution request history stored in the distribution-request-history storage unit 32e (see (3) in FIG. 17), the infected-terminal-identification-information extracting unit 33c reports the account information “aaa” to the second mail server or the third mail server (see (4) in FIG. 18). For example, the infected-terminal-identification-information extracting unit 33c reports the account information “aaa” to the third mail server (mail3.jp.xyz.com) in the form of an e-mail configured as shown in FIG. 21. In this embodiment, the infected-terminal-identification-information extracting unit 33c also reports the message ID “AAAAAAAA.11111111@jp.xyz.com” to the third mail server. In an extension header of the e-mail shown in FIG. 21, “X-trans:ON” is set to indicate that the e-mail is a terminal quarantine request.

Configuration of the mail server in the second embodiment.

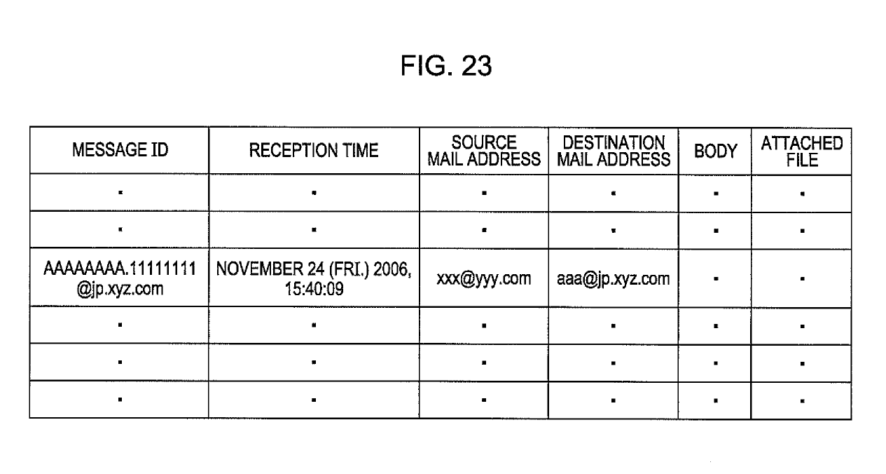

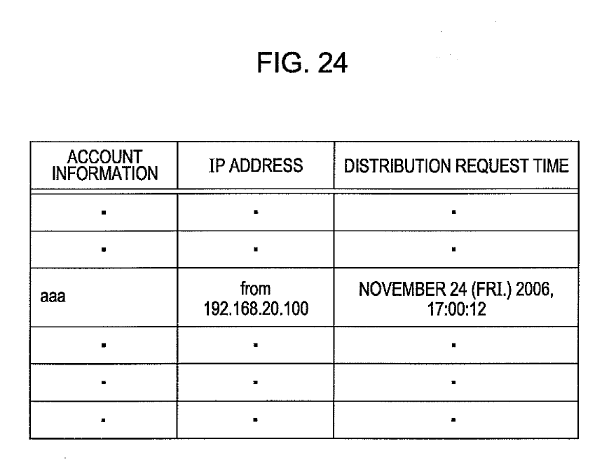

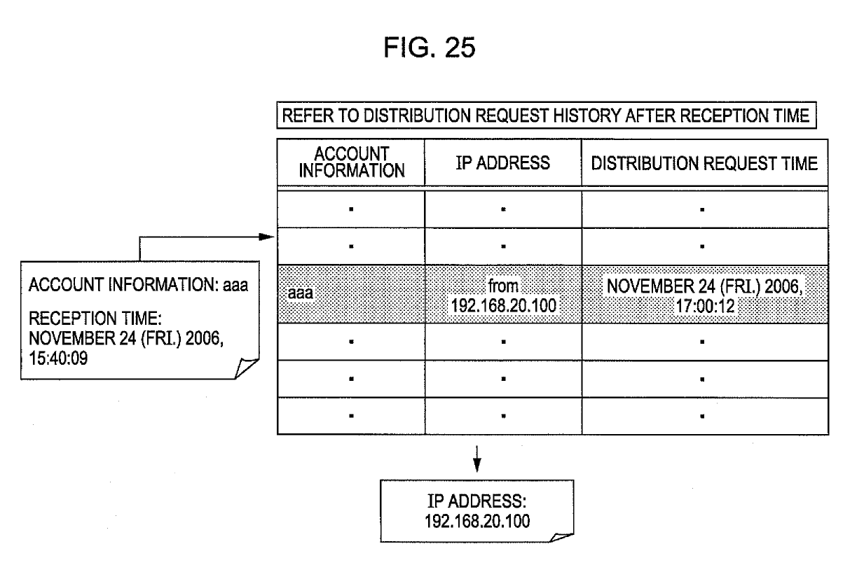

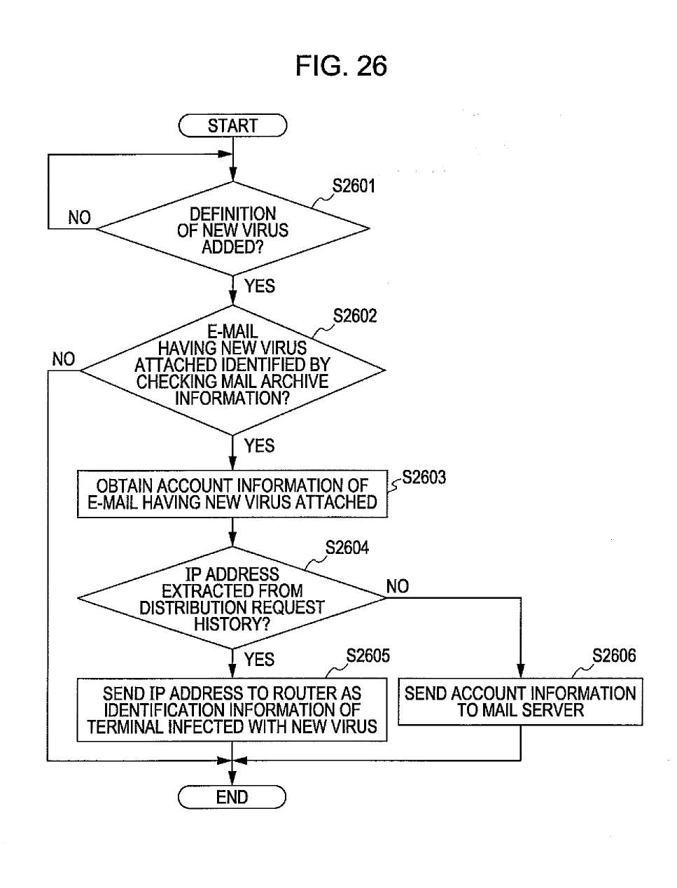

Next, the configuration of the mail server in the second embodiment will be described with reference to FIGS. 22 to 25. FIG. 22 is a block diagram showing the configuration of the mail server in the second embodiment. FIG. 23 is a diagram for explaining a mail-archive-information storage unit of the mail server in the second embodiment. FIG. 24 is a diagram for explaining a distribution-request-history storage unit of the mail server in the second embodiment. FIG. 25 is a diagram for explaining an infected-terminal-identification-information extracting unit of the mail server in the second embodiment.

As shown in FIG. 22, a mail server 40 in the second embodiment includes a communication controller 41, a storage unit 42, and a processing unit 43.

The communication controller 41 controls transfer of data that is both transmitted or received via a network. For example, the communication controller 41 sends and receives e-mails, receives account information, sends new-virus-infected-terminal identification information, and so forth according to communication protocols called SMTP/POP3.

The storage unit 42 stores both data used for various types of processing executed by the processing unit 43 and results of various types of processing executed by the processing unit 43. As components particularly relating to features of the present invention, as shown in FIG. 22, the storage unit 42 includes a mail-archive-information storage unit 42a, a received-account-information storage unit 42b, and a distribution-request-history storage unit 42c. The mail-archive-information storage unit 42a stores information of both e-mails received from the mail gateway 30 and e-mails which are both received from terminals in a network within the mail system and sent outside the mail system. The received-account-information storage unit 42b stores account information, etc. of an e-mail with a new virus. The account information is received from the mail gateway 30. The distribution-request-history storage unit 42c stores a distribution request history in which each distribution request is associated with identification information of a terminal that issued the distribution request.

The processing unit 43 executes various types of processing on the basis of both data transferred from the communication controller 41 and data stored in the storage unit 42. As a component particularly relating to a feature of the present invention, as shown in FIG. 22, the processing unit 43 includes an infected-terminal-identification-information extracting unit 43a. The infected-terminal-identification-information extracting unit 43a executes processing corresponding to an “infected-terminal-identification-information extracting” in claims.

The received-account-information storage unit 42b stores account information of an e-mail with a new virus. The account information is received from the mail gateway 30. The infected-terminal-identification-information extracting unit 43a obtains the account information from the received-account-information storage unit 42b. Furthermore, the infected-terminal-identification-information extracting unit 43a obtains the reception time of the e-mail with the new virus with reference to mail archive information that is stored in the mail-archive-information storage unit 42a. For example, from an e-mail which is both received from the mail gateway 30 and addressed to “mail3.jp.xyz.com”, as shown in FIG. 21, the infected-terminal-identification-information extracting unit 43a obtains account information “aaa” and a message ID “AAAAAAAA.11111111@jp.xyz.com” (see (6) in FIG. 18). Furthermore, with reference to the mail archive information stored in the mail-archive-information storage unit 42a, as shown in FIG. 23, the infected-terminal-identification-information extracting unit 43a obtains the reception time “November 24, 2006 (Fri.), 15:40:09” indicating the time of reception of the e-mail addressed to the terminal having the account information “aaa” (having the message ID “AAAAAAAA.11111111@jp.xyz.com”) received from the mail gateway 30. Alternatively, the infected-terminal-identification-information extracting unit 43a may obtain the reception time of the e-mail with reference to an SMTP reception log.

Then, with reference to the distribution request history stored in the distribution-request-history storage unit 42c, the infected-terminal-identification-information extracting unit 43a extracts an IP address that serves as new-virus-infected-terminal identification information, using both the obtained account information and the reception time of the e-mail with the new virus. For example, with reference to the distribution request history on and after “November 24, 2006 (Fri.), 15:40:09” in the distribution request history stored in the distribution-request-history storage unit 42c, as shown in FIG. 24, in response to a distribution request from the terminal having the account information “aaa” (having a distribution request time “November 24, 2006 (Fri.), 17:00:12”), the infected-terminal-identification-information extracting unit 43a extracts new-virus-infected-terminal identification information indicating that the IP address of the terminal that received the e-mail with the new virus is “192.168.20.100” (see FIG. 25).

Similarly to the mail server 10 in the first embodiment, the mail server 40 sends the extracted new-virus-infected-terminal identification information to the router 20 via the communication controller 41 (see (4) in FIG. 3). Similarly to the first embodiment, when the new-virus-infected terminal is included in terminals whose traffic is relayed by the router 20, the router 20 quarantines the new-virus-infected terminal from the network (see (7) in FIG. 3).

Since both the configuration of the router and the functions of components of the router in the second embodiment are the same as both the configuration of the router and the functions of components of the router in the first embodiment, so that description of the configuration of the router and the functions of components of the router in the second embodiment will be omitted.

Procedure of processing executed by the mail gateway in the second embodiment.

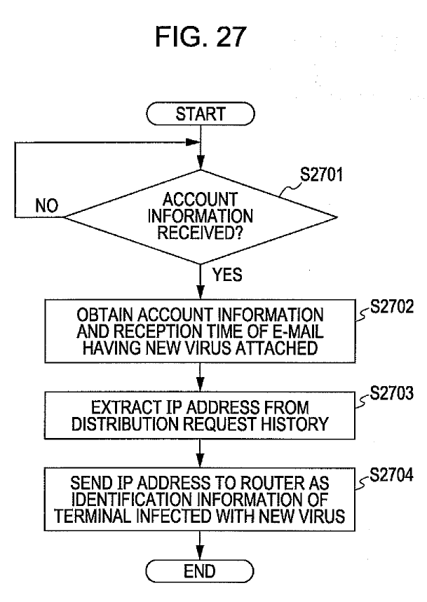

Next, processing executed by the mail gateway 30 in the second embodiment will be described with reference to FIG. 26. FIG. 26 is a flow chart for explaining a procedure of processing executed by the mail gateway 30 in the second embodiment.

At the mail gateway 30 in the second embodiment, first, when definitions of new viruses have been added to the virus definition file stored in the virus-definition-file storage unit 32a (Yes in operation S2601), the e-mail-with-new-virus identifying unit 33a checks the mail archive information stored in the mail-archive-information storage unit 32b (operation S2602). When no e-mail with a new virus, i.e., no e-mail with a new virus, is identified by the e-mail-with-new-virus identifying unit 33a (No in operation S2602), the e-mail-with-new-virus identifying unit 33a exits the procedure of FIG. 26.

On the other hand, when an e-mail with a new virus, i.e., an e-mail with a new virus, is identified by the e-mail-with-new-virus identifying unit 33a (Yes in operation S2602), the account-information obtaining unit 33b obtains account information from information of the e-mail with the new virus, stored in the identified-e-mail-with-new-virus storage unit 32c (operation S2603). For example, as shown in FIG. 20, the account-information obtaining unit 33b obtains the account information “aaa” together with the message ID “AAAAAAAA.11111111@jp.xyz.com” from the identified e-mail with the new virus.

Then, the infected-terminal-identification-information extracting unit 33c refers to the obtained account information and the distribution request history stored in the distribution-request-history storage unit 32e (operation S2604). When an IP address of a terminal that requested distribution of the e-mail with the new virus is extracted by the infected-terminal-identification-information extracting unit 33c (Yes in operation S2604), the mail gateway 30 sends the extracted IP address which serves as new-virus-infected-terminal identification information to a router directly connected to the mail gateway 30 (operation S2605). The procedure of FIG. 26 is then exited.

On the other hand, when no IP address of a terminal that requested distribution of the e-mail with the new virus is extracted by the infected-terminal-identification-information extracting unit 33c (No in operation S2604), the mail gateway 30 reports the account information “aaa” together with the message ID “AAAAAAAA.11111111@jp.xyz.com” to the mail server 40 (operation S2606). The procedure of FIG. 26 is then exited. For example, the mail gateway 30 reports the account information “aaa” together with the message ID “AAAAAAAA.11111111@jp.xyz.com” in the form of an e-mail configured as shown in FIG. 21.

When an e-mail with a new virus, i.e., an e-mail having a new virus attached to the e-mail, is identified by the infected-terminal-identification-information extracting unit 33c (Yes in operation S2602), information of the e-mail with the new virus may be deleted from the mail archive information stored in the mail-archive-information storage unit 32b. However, according to an aspect of an embodiment, the information need not necessarily be deleted.

Procedure of processing executed by the mail server in the second embodiment.

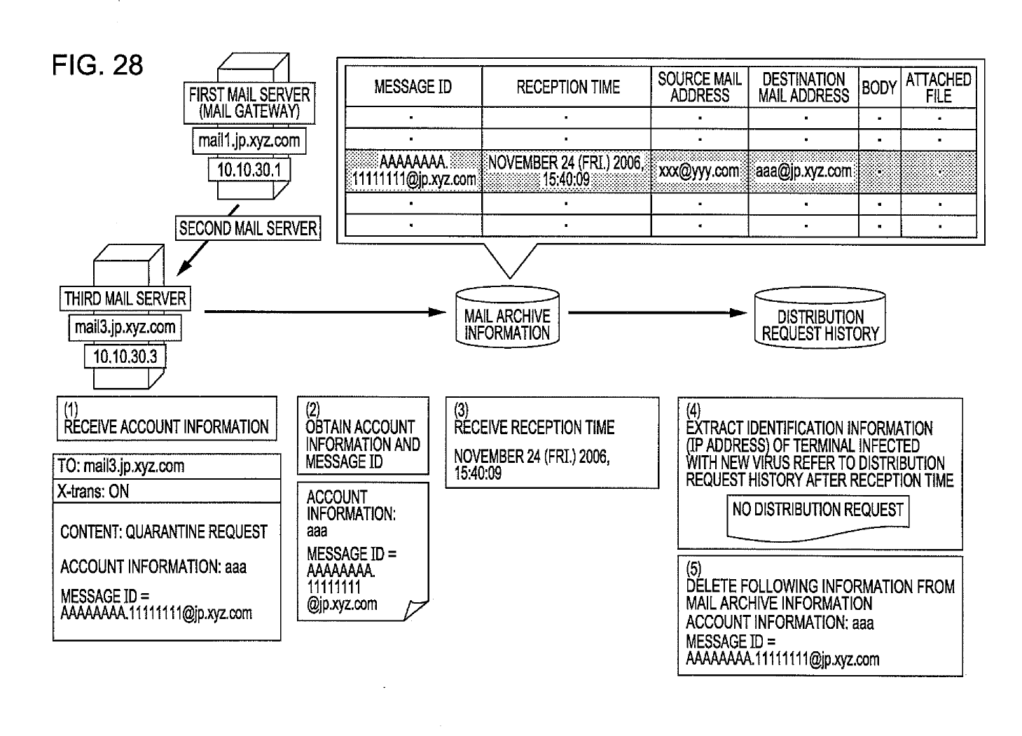

Next, processing executed by the mail server 40 in the second embodiment will be described with reference to FIG. 27. FIG. 27 is a flow chart for explaining a procedure of processing executed by the mail server 40 in the second embodiment.

At the mail server 40 in the second embodiment, first, when account information is received from the mail gateway 30 (Yes in operation S2701), the infected-terminal-identification-information extracting unit 43a obtains the account information. Furthermore, with reference to the mail archive information stored in the mail-archive-information storage unit 42a, the infected-terminal-identification-information extracting unit 43a obtains a reception time of an e-mail with a new virus (operation S2702).

For example, from an e-mail which is both received from the mail gateway 30 and addressed to “mail3.jp.xyz.com”, as shown in FIG. 21, the infected-terminal-identification-information extracting unit 43a obtains account information “aaa” and a message ID “AAAAAAAA.11111111@jp.xyz.com” (see (6) in FIG. 18). Furthermore, with reference to the mail archive information stored in the mail-archive-information storage unit 42a, as shown in FIG. 23, the infected-terminal-identification-information extracting unit 43a obtains “November 24, 2006 (Fri.), 15:40:09” indicating the time of reception of the e-mail addressed to the terminal having the account information “aaa” (having the message ID “AAAAAAAA.11111111@jp.xyz.com”) received from the mail gateway 30.

Then, with reference to the distribution request history, the infected-terminal-identification-information extracting unit 43a extracts an IP address of the terminal that requested distribution of the e-mail with the new virus, as new-virus-infected-terminal identification information, using both the account information and the reception time (operation 2703). For example, with reference to the distribution request history on and after “November 24, 2006 (Fri.), 15:40:09” in the distribution request history stored in the distribution-request-history storage unit 42c, shown in FIG. 24, in response to a distribution request from the terminal having the account information “aaa” (having a distribution request time “November 24, 2006 (Fri.), 17:00:12”), the infected-terminal-identification-information extracting unit 43a extracts new-virus-infected-terminal identification information indicating that the IP address of the terminal that received the e-mail with the new virus is “192.168.20.100” (see FIG. 25).

Then, the mail server 40 in the second embodiment sends the extracted new-virus-infected-terminal identification information to the router 20 directly connected to the mail server 40 (operation S2704). The procedure of FIG. 27 is then exited.

The procedure of processing executed by the router 20 in the second embodiment is the same as the procedure in the first embodiment, described earlier with reference to FIG. 15, so that description of the procedure will be omitted.

### Third Embodiment

In the second embodiment described above, when a mail server has extracted new-virus-infected-terminal identification information with reference to a distribution request history, the mail server sends the new-virus-infected-terminal identification information to a router. In a third embodiment described below, when no new-virus-infected-terminal identification information is extracted by a mail server with reference to a distribution request history, the mail server deletes information of a relevant e-mail with a new virus.

Overview and features of a mail system according to the third embodiment.

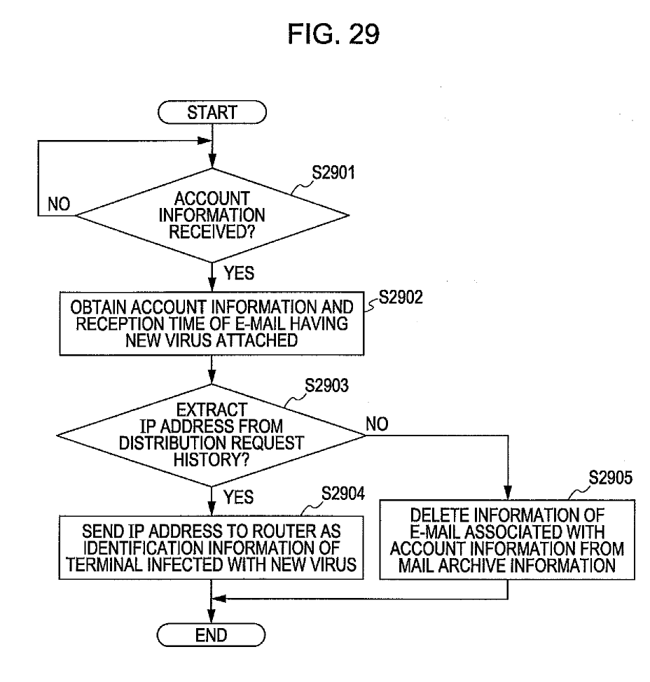

First, main features of a mail system according to the third embodiment will be described with reference to FIG. 28. FIG. 28 is a diagram for explaining an overview and features of the mail system according to the third embodiment.

Similarly to the mail system according to the second embodiment, the mail system according to the second embodiment includes a mail gateway, a plurality of mail servers, and a router. For example, as shown in FIG. 28, a first mail server which functions as a mail gateway is connected via a second mail server to a third mail server.

Similarly to the second embodiment, first, when definitions of new viruses have been added to the virus definition file, the mail gateway in the mail system according to the third embodiment checks the mail archive information to identify an e-mail with a new virus, i.e., an e-mail to which a new virus is attached. Then, the mail gateway obtains account information of the identified e-mail with the new virus. When the obtained account information is not included in the distribution request history, the mail gateway reports the account information to the other mail servers (see (1) to (3) in FIG. 17 and (4) in FIG. 18). For example, the mail gateway reports account information “aaa” and a message ID “AAAAAAAA.11111111@jp.xyz.com” to the second mail server (mail2.jp.xyz.com) and the third mail server (mail3.jp.xyz.com) in the form of an e-mail configured as shown in FIG. 21.

Similarly to the second embodiment, when each of the mail servers in the mail system according to the third embodiment receives the account information from the mail gateway, each of the mail servers obtains the account information. Furthermore, each of the mail servers obtains the reception time of the e-mail with the new virus with reference to the mail archive information. For example, when the third mail server receives an e-mail addressed to “mail3.jp.xyz.com”, as shown in FIG. 28, from the mail gateway via the second mail server (see (1) in FIG. 28), the third mail server obtains the account information “aaa” and the message ID “AAAAAAAA.11111111@jp.xyz.com” (see (2) in FIG. 28), Furthermore, with reference to the mail archive information, the third mail server obtains the reception time “November 24, 2006 (Fri.), 15:40:09” indicating the time of reception of the e-mail that is addressed to the terminal having the account information “aaa” (having the message ID “AAAAAAAA.11111111@jp.xyz.com”) received from the mail gateway via the second mail server (see (3) in FIG. 28).

Then, with reference to the distribution request history, each of the mail servers in the mail system according to the third embodiment extracts an IP address that serves as new-virus-infected-terminal identification information, using both the obtained account information and the reception time of the e-mail with the new virus. When the distribution request history does not include any distribution request from the terminal having the account information on and after the time of reception of the e-mail with the new virus from the mail gateway, the mail server deletes information of the e-mail with the new virus from the mail archive information stored in the mail server.

That is, with reference to the distribution request history on and after “November 24, 2006 (Fri.), 15:40:09” in the distribution request history, when no request from the terminal having the account information “aaa” is included (see (4) in FIG. 28), the third mail server deletes information of the e-mail addressed to the terminal having the account information “aaa” (having the message ID “AAAAAAAA.11111111@jp.xyz.com”) from the mail archive information (see (5) in FIG. 28).

Configuration of the mail server in the third embodiment.

Next, the configuration of the mail server in the third embodiment will be described with reference to FIG. 22. The configuration of the mail gateway 30 and the functions of components of the mail gateway 30 in the third embodiment are the same as the configuration of the mail gateway 30 and the functions of components of the mail gateway 30 in the second embodiment, described earlier with reference to FIG. 19, so that description of the configuration of the mail gateway 30 and the functions of components of the mail gateway 30 will be omitted. FIG. 22 is a block diagram showing the configuration of the mail server in the second embodiment.

As shown in FIG. 22, the mail server 40 shown in FIG. 3 is configured the same as the mail server 40 in the second embodiment. However, processing executed by the infected-terminal-identification-information extracting unit 43a differs. The following description will be directed mainly to this point.

The received-account-information storage unit 42b stores account information of an e-mail with a new virus. The account information is received from the mail gateway 30. The account information is stored in the received-account-information storage unit 42b. From the account information, the infected-terminal-identification-information extracting unit 43a obtains the account information. Furthermore, with reference to the mail archive information stored in the mail-archive-information storage unit 42a, the infected-terminal-identification-information extracting unit 43a obtains the reception time of the e-mail with the new virus. For example, as shown in FIG. 28, the infected-terminal-identification-information extracting unit 43a obtains the account information “aaa,” the message ID “AAAAAAAA.11111111@jp.xyz.com,” and the reception time “November 24, 2006 (Fri.), 15:40:09.” Alternatively, the infected-terminal-identification-information extracting unit 43a may obtain the reception time of the e-mail with reference to an SMTP reception log.

Then, with reference to the distribution request history stored in the distribution-request-history storage unit 42c, the infected-terminal-identification-information extracting unit 43a extracts an IP address that serves as new-virus-infected-terminal identification information, using both the obtained account information and the reception time of the e-mail with new virus. When the distribution request history does not include any distribution request from the terminal having the account information on and after the time of reception by the mail server of the e-mail with the new virus from the mail gateway, the infected-terminal-identification-information extracting unit 43a deletes information of the e-mail with the new virus from the mail archive information stored in the mail-archive-information storage unit 42a. For example, with reference to the distribution request history on and after “November 24, 2006 (Fri.), 15:40:09” in the distribution request history stored in the distribution-request-history storage unit 42c, when no request from the terminal having the account information “aaa” is included (see (4) in FIG. 28), the infected-terminal-identification-information extracting unit 43a deletes information of the e-mail addressed to the terminal having the account information “aaa” (having the message ID “AAAAAAAA.11111111@jp.xyz.com”) from the mail archive information stored in the mail-archive-information storage unit 42a (see (5) in FIG. 28).

Procedure of processing executed by the mail server in the third embodiment.

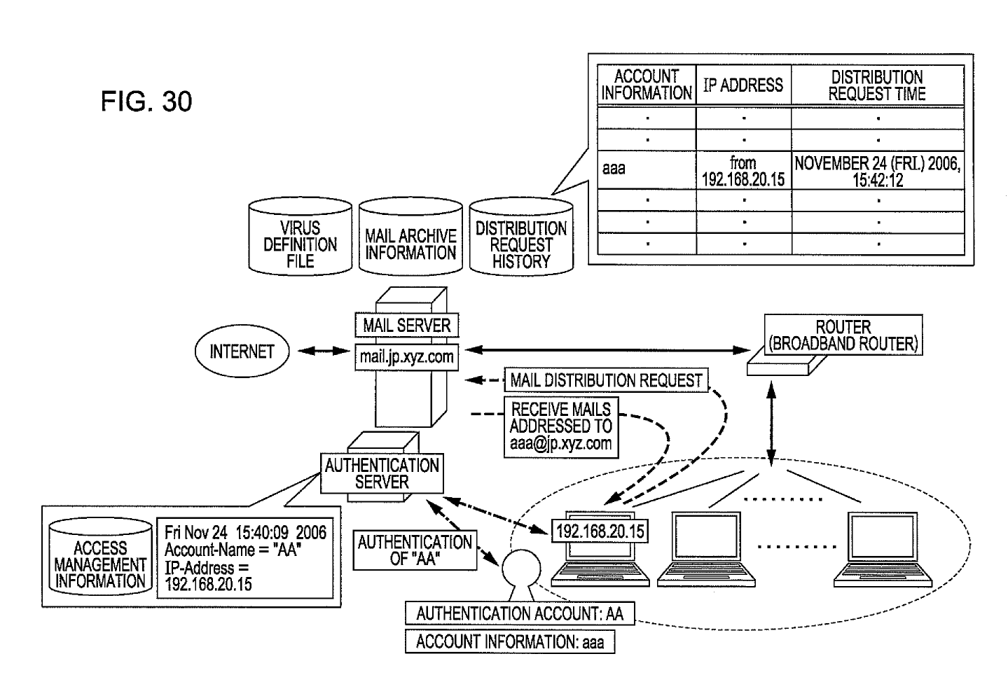

Next, processing executed by a mail server 40 in the third embodiment will be described with reference to FIG. 29. The procedure of processing executed by the mail gateway 30 in the third embodiment is the same as the procedure in the second embodiment, described with reference to FIG. 26, so that description of the procedure will be omitted. FIG. 29 is a flow chart for explaining a procedure of processing executed by the mail server 40 in the third embodiment.

At the mail server 40 in the third embodiment, when account information is received from the mail gateway 30 (Yes in operation S2901), first, the infected-terminal-identification-information extracting unit 43a obtains the account information. Furthermore, with reference to the mail archive information stored in the mail-archive-information storage unit 42a, the infected-terminal-identification-information extracting unit 43a obtains the reception time of the e-mail with the new virus (operation S2902). For example, as shown in FIG. 28, the infected-terminal-identification-information extracting unit 43a obtains the account information “aaa,” the message ID “AAAAAAAA.11111111@jp.xyz.com,” and the reception time “November 24, 2006 (Fri.), 15:40:09.”

Then, the infected-terminal-identification-information extracting unit 43a refers to the distribution request history using both the account information and the reception time (operation S2903). An IP address of a terminal that requested distribution of the e-mail with the new virus which serves as new-virus-infected-terminal identification information. When the IP address is extracted by the infected-terminal-identification-information extracting unit 43a (Yes in operation S2903), the mail server 40 sends the extracted new-virus-infected-terminal identification information to the router 20 directly connected to the mail server 40 (operation S2904). The procedure of FIG. 29 is then exited.

On the other hand, when no IP address of a terminal that requested distribution of the e-mail with the new virus is extracted by the infected-terminal-identification-information extracting unit 43a (No in operation S2903), the infected-terminal-identification-information extracting unit 43a deletes information of the e-mail with the new virus from the mail archive information stored in the mail-archive-information storage unit 42a (operation S2905). The procedure of FIG. 29 is then exited. For example, as shown in FIG. 28, since the distribution request history does not include any distribution request on and after the reception time (November 24, 2006 (Fri.), 15:40:09) of reception of the e-mail which is addressed to the terminal that has the account information “aaa” and the message ID “AAAAAAAA.11111111@jp.xyz.com,” the infected-terminal-identification-information extracting unit 43a deletes information of the e-mail with the new virus from the mail archive information stored in the mail server 40.

### Fourth Embodiment

The first to third embodiments described above relate to cases where an IP address used as terminal identification information of a terminal is fixed. A fourth embodiment described below relates to a case where an IP address used as terminal identification information of a terminal is changed each time the terminal connects to a network.

Overview and features of a mail system according to the fourth embodiment.

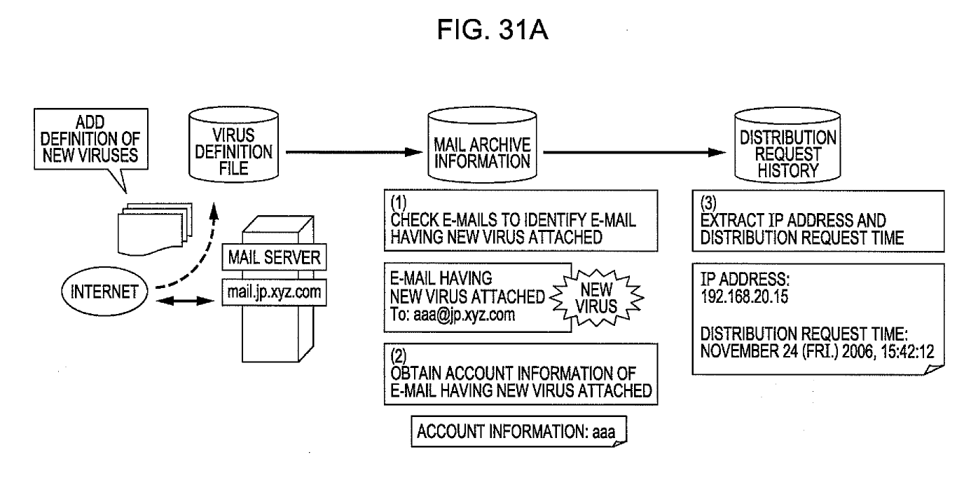

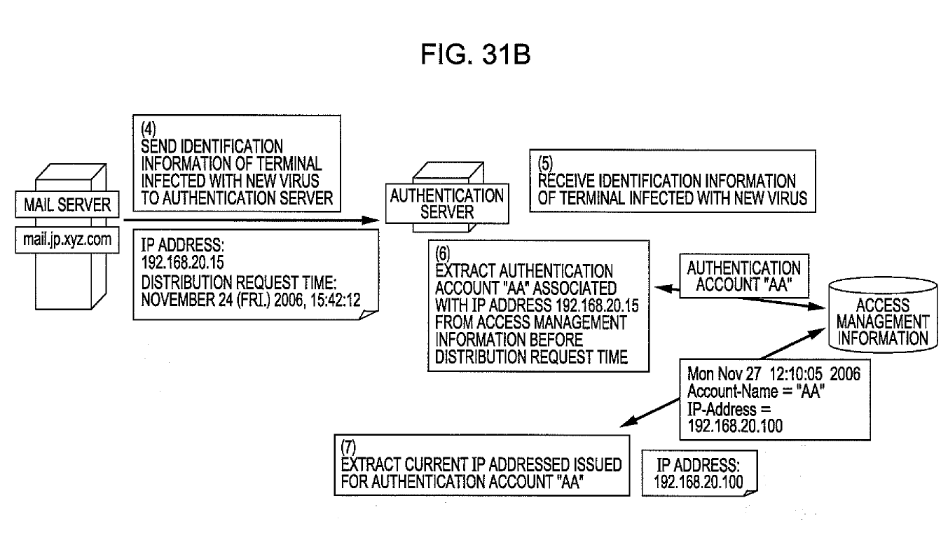

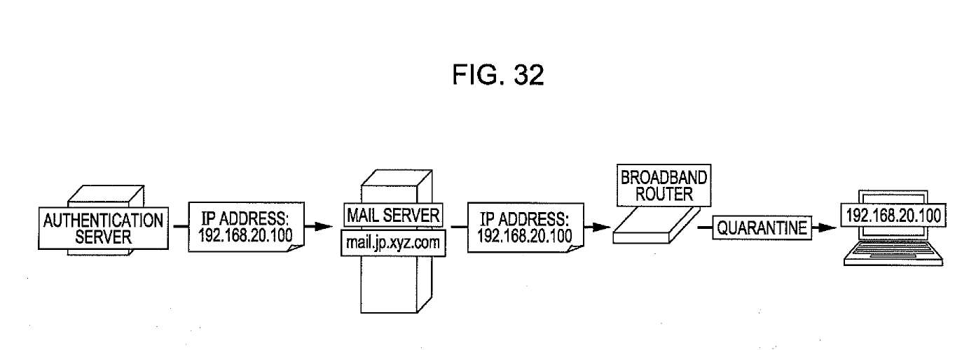

First, main features of a mail system according to the fourth embodiment will be described with reference to FIGS. 30 to 32. FIG. 30 is a diagram for explaining an overview of the mail system according to the fourth embodiment. FIGS. 31 and 32 are operation flow diagrams for explaining features of the mail system according to the fourth embodiment.

Similarly to the first embodiment, in the mail system according to the fourth embodiment, as shown in FIG. 30, information of e-mails is stored in mail archive information. Furthermore, the mail system distributes e-mails addressed to a terminal in response to a distribution request from the terminal. The mail system stores a distribution request history in which each distribution request is associated with terminal identification information of a terminal that issued the distribution request. The mail system includes a mail server that checks received e-mails on the basis of a virus definition file, and a router (e.g., a broadband router) that relays exchange of e-mails between the mail server and terminals.

The mail server in the mail system according to the fourth embodiment issues an IP address to a terminal as terminal identification information on each occasion of authentication of connection of the terminal to a network, using an authentication account that serve as client user identification for identifying a client user that operates the terminal. The mail server is connected to an authentication server that stores access management information in which authentication accounts are associated individually with IP addresses. The authentication account corresponds to “client user identification information” in claims.

For example, as shown in FIG. 30, when a client user who both has a terminal in a network whose traffic is relayed by a broadband router that serves as the router in the mail system and has an authentication account “AA” connects the terminal to the Internet, the mail server reports the authentication account “AA” and an appropriate password to the authentication server connected to the mail server which is in charge of a domain having a domain name “jp.xyz.com.” The authentication server executes authentication and issues an IP address “192.168.20.15” as terminal identification information to the terminal. And the authentication server stores access management information in which the authentication account is associated with the IP address. For example, as shown in FIG. 30, as the authentication account, the IP address, and an authentication time, the authentication server stores ‘Account-Name=“AA,” “IP-Address=192.168.20.15,” and “Fri Nov 24 15:40:09 2006”.’

In response to a distribution request from a terminal owned by the client user having the authentication account “AA” and the account information “aaa” and having an IP address “192.168.20.15” to which the client user is assigned, the mail server in the mail system according to the fourth embodiment distributes e-mails addressed to “aaa@jp.xyz.com” to the terminal via the router.

Furthermore, the IP address in the distribution request history serves as terminal identification information of the terminal. As shown in FIG. 30, the mail server in the mail system according to the fourth embodiment stores “aaa@jp.xyz.com” in association with the IP address “192.168.20.15.” The mail server also stores the distribution request time “November 24, 2006 (Fri.), 15:42:12” representing a time of reception of the distribution request from the terminal.

Then, similarly to the first embodiment, when definitions of new viruses have been added to the virus definition file, the mail server in the mail system according to the fourth embodiment checks the mail archive information to identify an e-mail with a new virus, i.e., an e-mail having a new virus attached to the e-mail.

More specifically, as shown in FIG. 31A, when definitions of new viruses have been added to the virus definition file, the mail server checks the mail archive information to identify an e-mail with a new virus, i.e., an e-mail having a new virus attached to the e-mail. For example, the mail server identifies that a new virus is attached to an e-mail addressed to “aaa@jp.xyz.com” (see (1) in FIG. 31A).

Then, similarly to the first embodiment, the mail server in the mail system according to the fourth embodiment obtains account information of the identified e-mail with the new virus. For example, the mail server obtains account information “aaa” from the identified e-mail with the new virus (see (2) in FIG. 31A).

Then, from the distribution request history, the mail server in the mail system according to the fourth embodiment extracts both the IP address issued to the terminal by the authentication server at the time of a distribution request of the e-mail with a new virus and the distribution request time of the distribution request of the e-mail with the new virus by the terminal.

More specifically, with reference to the distribution request history shown in FIG. 30, in response to a distribution request from the terminal having the account information “aaa”, the mail server extracts both the IP address “192.168.20.15” of the terminal that received the e-mail with the new virus and the distribution request time “November 24, 2006 (Fri.), 15:42:12” (see (3) in FIG. 31A).

Then, in order to request to search for a current IP address, the mail server in the mail system according to the fourth embodiment sends the extracted IP address and the extracted distribution request time to the authentication server. That is, the mail server sends the IP address “192.168.20.15” and the distribution request time “November 24, 2006 (Fri.), 15:42:12” to the authentication server (see (4) in FIG. 31B).

Then, the authentication server in the mail system according to the fourth embodiment receives the IP address and the distribution request time which were sent from the mail server (see (5) in FIG. 31B). With reference to the received IP address and the received distribution request time and the access management information, the authentication server extracts an authentication account associated with the terminal that received the e-mail with the new virus.

More specifically, from the access management information on and before the distribution request time, the authentication server extracts an authentication account to which the IP address was issued. For example, from the access management information shown in FIG. 30, the authentication server extracts the authentication account “AA” to which the IP address “192.168.20.15” was issued at “November 24, 2006 (Fri.), 15:40:09” which is before the distribution request time “November 24, 2006 (Fri.), 15:42:12” (see (6) in FIG. 31B).

When a new IP address has been issued to the terminal authenticated on the basis of the authentication account, the authentication server in the mail system according to the fourth embodiment extracts the new IP address as new-virus-infected-terminal identification information.

For example, as shown in FIG. 31B, with reference to the current access management information (e.g., “November 27, 2006 (Mon.), 12:12:00”), the authentication server detects ‘Account-Name=“AA”,’ “IP-Address=192.168.20.100,” and “Mon Nov 27 12:10:05 2006.” Then, since a new IP address (192.168.20.100) has been issued to the terminal authenticated on the basis of the authentication account “AA” on “November 27, 2006 (Mon.), 12:10:05,” the authentication server extracts the IP address “192.168.20.100” as new-virus-infected-terminal identification information (see (7) in FIG. 31B).

Then, the authentication server in the mail system according to the fourth embodiment sends the new-virus-infected-terminal identification information to the mail server. The mail server extracts the received new-virus-infected-terminal identification information. The mail server sends the new-virus-infected-terminal identification information to the broadband router. Similarly to the first embodiment, when the new-virus-infected terminal is included in terminals whose traffic is relayed by the broadband router, the broadband router quarantines the new-virus-infected terminal from the network.

That is, similarly to the first embodiment, as shown in FIG. 32, When the broadband router that has received the IP address “192.168.20.100” from the authentication server via the mail server determines that the terminal having the IP address “192.168.20.100” is included in the terminals whose traffic is relayed by the broadband router, the broadband router quarantines the terminal from the network.

Configuration of the mail server in the fourth embodiment.

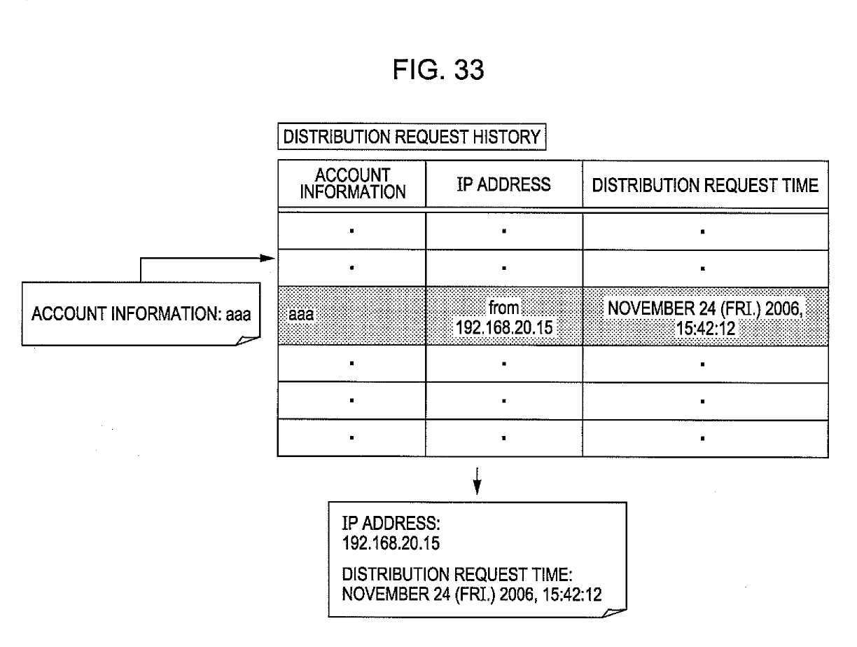

Next, the configuration of the mail server in the fourth embodiment will be described with reference to FIGS. 4 and 33. FIG. 4 is a block diagram showing the configuration of the mail server in the first embodiment. FIG. 33 is a diagram for explaining an infected-terminal-identification-information extracting unit of the mail server in the fourth embodiment.

As shown in FIG. 4, a mail server 10 in the fourth embodiment is configured the same as the mail server 10 in the first embodiment. However, processing executed by the communication controller 11 and the infected-terminal-identification-information extracting unit 13c differs. The following description will be directed mainly to this point.

The communication controller 11 controls transfer of data transmitted or received via a network. More specifically, the communication controller 11 sends and receives e-mails, receives definitions of new viruses, carries out communications with the authentication server, sends new-virus-infected-terminal identification information, and so forth according to communication protocols called SMTP/POP3.

Similarly to the first embodiment, when definitions of new viruses have been added to the virus definition file, the e-mail-with-new-virus identifying unit 13a checks the mail archive information to identify an e-mail with a new virus. The account-information obtaining unit 13b obtains account information from the e-mail with the new virus. For example, the e-mail-with-new-virus identifying unit 13a identifies an e-mail with a new virus addressed to a destination mail address “aaa@jp.xyz.com.” The account-information obtaining unit 13b obtains account information “aaa” from the e-mail with the new virus.

With reference to both the account information stored in the obtained-account-information storage unit 12d and the distribution request history stored in the distribution-request-history storage unit 12e , from the distribution request history, the infected-terminal-identification-information extracting unit 13c extracts both the IP address issued by the authentication server to the terminal at the time of the distribution request of the e-mail with the new virus and the distribution request time of the distribution request of the e-mail with the new virus by the terminal.

More specifically, as shown in FIG. 33, with reference to the distribution request history, in response to the distribution request from the terminal having the account information “aaa,” the infected-terminal-identification-information extracting unit 13c extracts both the IP address “192.168.20.15” of the terminal that received the e-mail with the new virus and the distribution request time “November 24, 2006 (Fri.), 15:42:12.”

The communication controller 11 sends the IP address and the distribution request time which were obtained by the infected-terminal-identification-information extracting unit 13c to the authentication server in order to request to search for a current IP address.

Furthermore, the communication controller 11 receives and extracts the IP address extracted by the authentication server. The IP address serves as new-virus-infected-terminal identification information. The communication controller 11 sends the IP address to the router 20.

Configuration of the authentication server in the fourth embodiment.

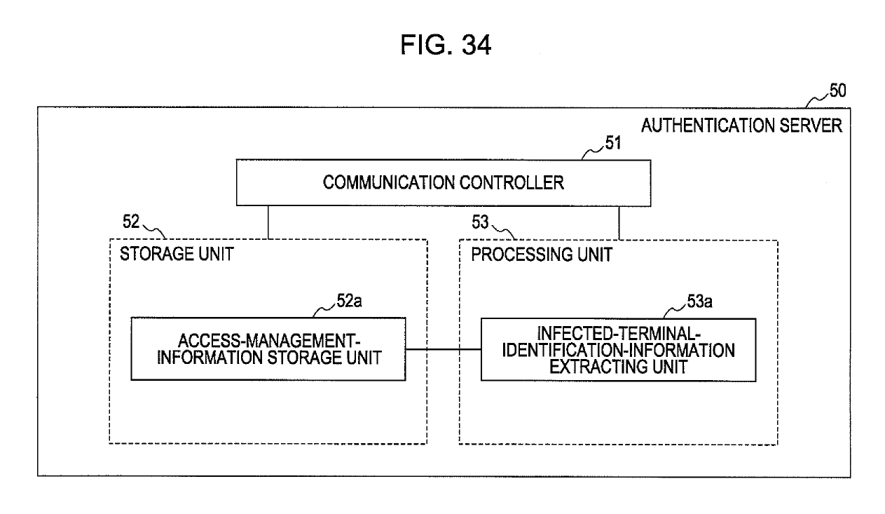

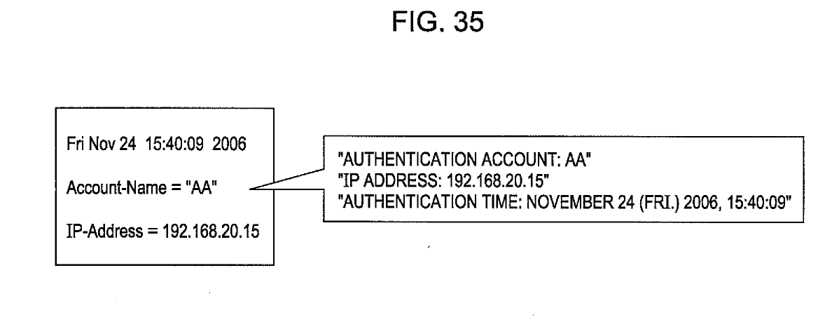

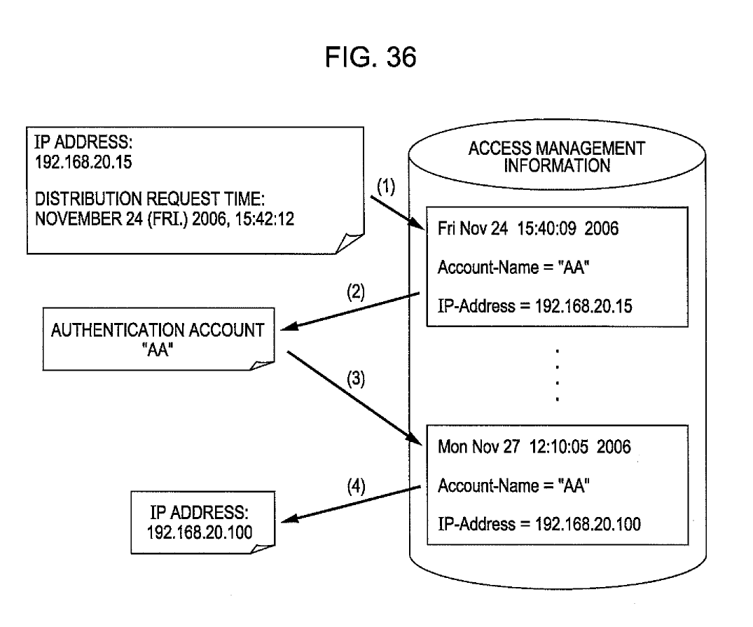

Next, the configuration of the authentication server in the fourth embodiment will be described with reference to FIGS. 34 to 36. FIG. 34 is a block diagram showing the configuration of the authentication server in the fourth embodiment. FIG. 35 is a diagram for explaining an access-management-information storage unit. FIG. 36 is a diagram for explaining an infected-terminal-identification-information extracting unit of the authentication server in the fourth embodiment.

As shown in FIG. 34, an authentication server 50 in the fourth embodiment includes a communication controller 51, a storage unit 52, and a processing unit 53.

The communication controller 51 receives authentication account from terminals, IP addresses and distribution request times from the mail server 10. The communication controller 51 sends new-virus-infected-terminal identification information to the mail server 10, and so forth.

The storage unit 52 stores data used for various types of processing executed by the processing unit 53. As a component particularly relating to a feature of the present invention, as shown in FIG. 34, the storage unit 52 includes an access-management-information storage unit 52a.

As access management information, the access-management-information storage unit 52a stores an IP address issued by the authentication server 50 after the access-management-information storage unit 52a received an authentication account from the terminal which a client user operates. For example, as shown in FIG. 35, the access-management-information storage unit 52a stores an IP address “192.168.20.15” issued to the terminal as a result of authentication of an authentication account “AA” that was received from the terminal, in association with an authentication time “November 24, 2006 (Fri.), 155:40:09.”

The processing unit 53 executes various types of processing on the basis of both data transferred from the communication controller 51 and data stored in the storage unit 52. As a component particularly relating to a feature of the present invention, as shown in FIG. 34, the processing unit 53 includes an infected-terminal-identification-information extracting unit 53a.

With reference to the IP address and the distribution request time which have been received from the mail server 10 and to the access management information stored in the access-management-information storage unit 52a, the infected-terminal-identification-information extracting unit 53a extracts an authentication account associated with the terminal that received the e-mail with the new virus.

More specifically, the infected-terminal-identification-information extracting unit 53a extracts an authentication account to which the IP address was issued from the access management information on and before the distribution request time. For example, as shown in FIG. 36, the infected-terminal-identification-information extracting unit 53a refers to the access management information on and before the distribution request time using both the distribution request time “November 24, 2006 (Fri.), 15:42:12” and the IP address “192.168.20.15” (see (1) in FIG. 36). The infected-terminal-identification-information extracting unit 53a extracts an authentication account “AA” to which the IP address “192.168.20.15” was issued at “November 24, 2006 (Fri.), 15:40:09,” which is before the distribution request time.

Then, when a new IP address has been issued as a result of authentication of the authentication account, the infected-terminal-identification-information extracting unit 53a extracts the new IP address as new-virus-infected-terminal identification information.

For example, as shown in FIG. 36, the infected-terminal-identification-information extracting unit 53a refers to the current access management information (e.g., “November 27, 2006 (Mon.), 12:12:00”) to determine whether a new IP address has been issued to the authentication account “AA” (see (3) in FIG. 36). The infected-terminal-identification-information extracting unit 53a detects information of ‘Account-Name=“AA”,’ “IP-Address=192.168.20.100,” and “Mon Nov 27 12:10:05 2006.” The infected-terminal-identification-information extracting unit 53a extracts the IP address “192.168.20.100” as new-virus-infected-terminal identification information (see (4) in FIG. 36).

The authentication server 50 sends the new-virus-infected-terminal identification information extracted by the infected-terminal-identification-information extracting unit 53a to the mail server 10. For example, the authentication server 50 sends the IP address “192.168.20.100” as new-virus-infected-terminal identification information.

The configuration of the router and the functions of components of the router in the fourth embodiment are the same as those in the first embodiment, described earlier with reference to FIG. 11, so that description of the router will be omitted.

Procedure of processing executed by the mail server in the fourth embodiment.

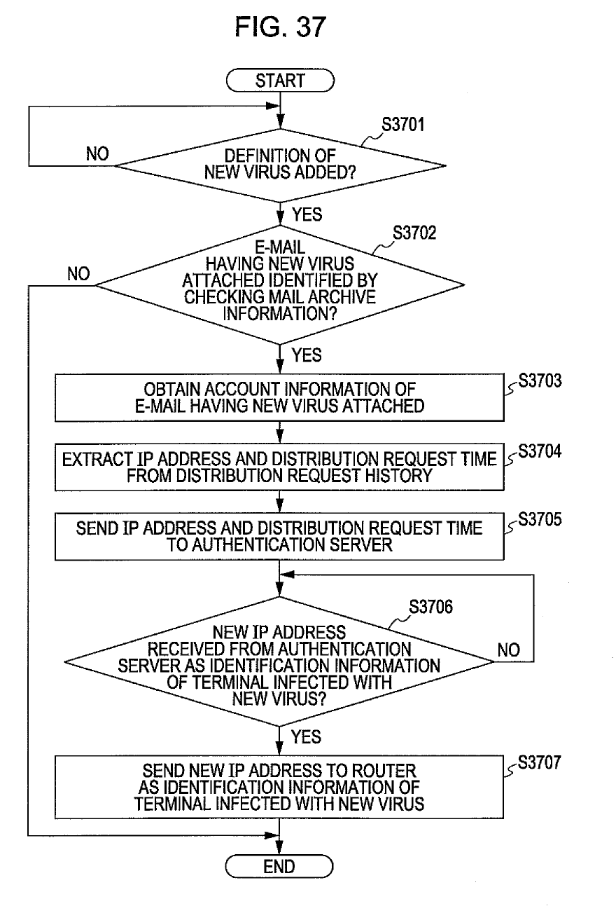

Next, processing executed by the mail server 10 in the fourth embodiment will be described with reference to FIG. 37. FIG. 37 is a flow chart for explaining a procedure of processing executed by the mail server 10 in the fourth embodiment.

At the mail server 10 in the fourth embodiment, first, when definitions of new viruses have been added to the virus definition file stored in the virus-definition-file storage unit 12a (Yes in operation S3701), the e-mail-with-new-virus identifying unit 13a checks the mail archive information stored in the mail-archive-information storage unit 12b (operation S3702). At the mail server 10, when no e-mail with a new virus, i.e., no e-mail having a new virus attached to the e-mail, is identified by the e-mail-with-new-virus identifying unit 13a (No in operation S3702), the procedure of FIG. 37 is exited.

On the other hand, when an e-mail with a new virus, i.e., an e-mail to which a new virus is attached, is identified by the e-mail-with-new-virus identifying unit 13a (Yes in operation S3702), the account-information obtaining unit 13b obtains account information from information of the e-mail having with the new virus attached to the e-mail (operation S3703). The information of the e-mail with the new virus is stored in the identified-e-mail-with-new-virus storage unit 12c. For example, the account-information obtaining unit 13b obtains account information “aaa” from the identified e-mail with the new virus (see (2) in FIG. 31).

Then, with reference to both the obtained account information and the distribution request history stored in the distribution-request-history storage unit 12e , from the distribution request history, the infected-terminal-identification-information extracting unit 13c extracts both an IP address issued by the authentication server to the terminal at the time of the distribution request of the e-mail with the new virus and the distribution request time of the distribution request of the e-mail with the new virus by the terminal (operation S3704). More specifically, as shown in FIG. 33, with reference to the distribution request history, in response to the distribution request from the terminal having the account information “aaa,” the infected-terminal-identification-information extracting unit 13c extracts both the IP address “192.168.20.15” of the terminal that received the e-mail with the new virus and the distribution request time “November 24, 2006 (Fri.), 15:42:12.”

Then, the mail server 10 sends the IP address and the distribution request time that have been extracted by the infected-terminal-identification-information extracting unit 13c to the authentication server (operation S3705).

Then, when the mail server 10 receives a new IP address from the authentication server 50 as new-virus-infected-terminal identification information (Yes in operation S3706), the mail server 10 sends the new IP address extracted as new-virus-infected-terminal identification information to the router 20 (operation S3707). The procedure of FIG. 37 is then exited.

Procedure of processing executed by the authentication server in the fourth embodiment.

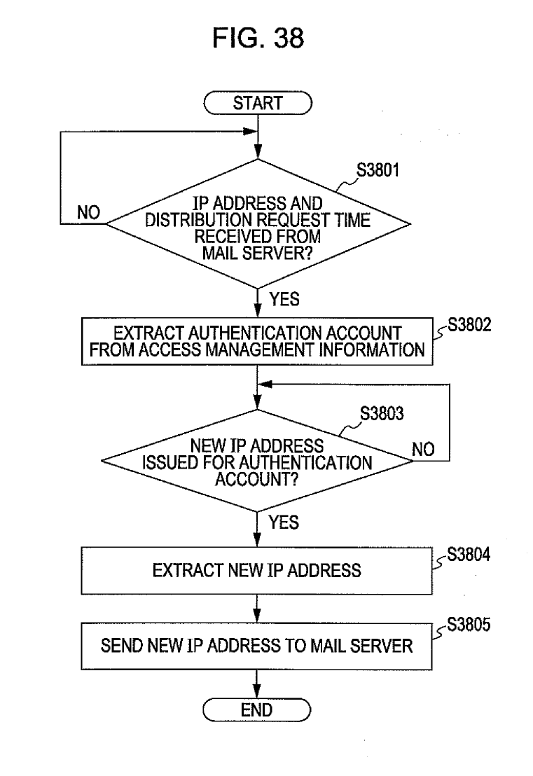

Next, processing executed by the authentication server 50 in the fourth embodiment will be described with reference to FIG. 38. FIG. 38 is a flow chart for explaining a procedure of processing executed by the authentication server 50 in the fourth embodiment.

At the authentication server 50 in the fourth embodiment, first, upon receiving an IP address and a distribution request time from the mail server 10 (Yes in operation S3801), with reference to the received IP address and the received distribution request time and to the access management information stored in the access-management-information storage unit 52a, the infected-terminal-identification-information extracting unit 53a extracts an authentication account associated with the terminal that received the e-mail with the new virus (operation S3802).

For example, as shown in FIG. 36, the infected-terminal-identification-information extracting unit 53a refers to the access management information on and before the distribution request time using both the distribution request time “November 24, 2006 (Fri.), 15:42:12” and the IP address “192.168.20.15” (see (1) in FIG. 36). The infected-terminal-identification-information extracting unit 53a extracts an authentication account “AA” from the access management information which includes the IP address “192.168.20.15” that was issued at “November 24, 2006 (Fri.), 15:40:09” which is before the distribution request time (see (2) in FIG. 36).

Then, when a new IP address has been issued to the terminal as a result of authentication of the authentication account (Yes in operation S3803), the infected-terminal-identification-information extracting unit 53a extracts the new IP address as new-virus-infected-terminal identification information (operation S3804).

For example, as shown in FIG. 36, with reference to the current access management information (e.g., “November 27, 2006 (Mon.), 12:12:00”), the infected-terminal-identification-information extracting unit 53a determines whether a new IP address has been issued to the authentication account “AA” (see (3) in FIG. 36). The infected-terminal-identification-information extracting unit 53a extracts an IP address “192.168.20.100” as new-virus-infected-terminal identification information (see (4) in FIG. 36).

Then, the authentication server 50 sends the new-virus-infected-terminal identification information extracted by the infected-terminal-identification-information extracting unit 53a to the mail server 10 (operation S3805). The procedure of FIG. 38 is then exited. For example, the authentication server 50 sends the IP address “1192.168.20.100” as new-virus-infected-terminal identification information to the mail server 10.

The procedure of processing executed by the router 20 in the fourth embodiment is the same as the procedure in the first embodiment, described earlier with reference to FIG. 15, so that description the procedure of processing executed by the router 20 in the fourth embodiment will be omitted.

### Other Embodiments

Although the mail systems according to the first to fourth embodiments have been described above, the present invention can be embodied in various forms other than the embodiments described above. The following description will be directed to mail systems according to various other embodiments, regarding points (1) to (3).

(1) Sending of New-Virus-Infected-Terminal Identification Information.

In the first embodiment described earlier, when a router receives new-virus-infected-terminal identification information which is sent from a mail server and the router determines that no corresponding terminal is included in a sub-network that the router is in charge of, the router sends the new-virus-infected-terminal identification information to another terminal. However, the present invention is not limited to this case, and the mail server may send new-virus-infected-terminal identification information simultaneously to all routers.

Furthermore, in the first embodiment, an IP packet in which an IP address that serves as new-virus-infected-terminal identification information is specified both in an IP header and in data of the IP packet is sent to a router. However, the present invention is not limited to this case, and an IP packet in which an IP address that serves as new-virus-infected-terminal identification information is specified only in an IP header may be sent to a router.

(2) System Configuration, etc.

Furthermore, in the procedures executed in the embodiments described above, some or all of the operations that have been described as executed automatically may be executed manually (e.g., when definitions of new viruses have been added, an administrator of a mail server can instruct start of checking of mail archive information instead of automatically starting checking of the mail archive information). Alternatively, some or all the operations that have been described as executed manually can be executed automatically. Furthermore, the processing procedures, specific names, and information which includes various types of data or parameters, described in this specification or shown in the drawings, can be modified as desired unless otherwise specifically described.

Furthermore, the components of each of the devices shown in the drawings schematically represent functions, and the components need not necessarily be physically configured as shown. That is, the specific manner of separation and integration of individual processing units and individual storage units (e.g., shown in FIG. 4) is not limited to those units shown in the drawings. That is, the entirety or some of the units may be physically separated or integrated in arbitrary units in accordance with various loads or operation statuses, for example, the account-information obtaining unit 13b and the infected-terminal-identification-information extracting unit 13c may be integrated. Furthermore, the entirety or an arbitrary part of the processing functions of the individual devices can be implemented by central processing units (CPUs) and programs parsed and executed by the CPUs, or by hardware in the form of wired logics.

(3) Terminal Identifying Program.

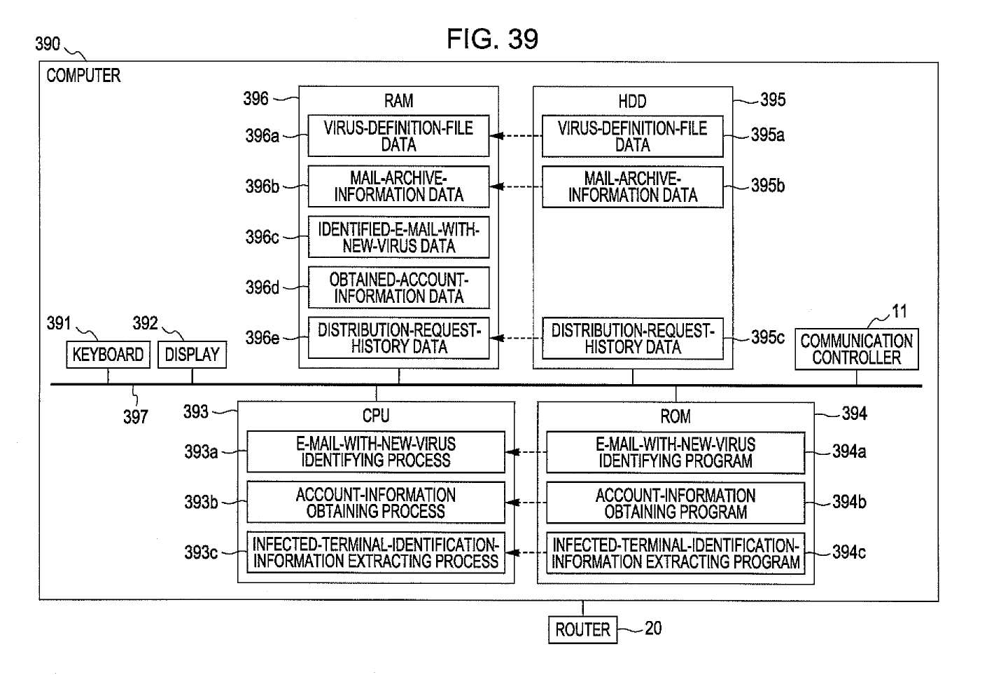

The embodiments may be implemented in software and/or computing hardware. Although various types of processing are executed by hardware logics in the first to fourth embodiments described above, the present invention is not limited to this case, and programs prepared in advance may be executed by computers. Now, an example of a computer that executes a terminal identifying program having the same functions as the mail server 10 in the mail system according to the first embodiment will be described with reference to FIG. 39. FIG. 39 is a diagram showing a computer that executes a terminal identifying program corresponding to the first embodiment.

As shown in FIG. 39, in a computer 390 that functions as an information processing apparatus, a keyboard 391, a display 392, a central processing unit (CPU) 393, a read-only memory (ROM) 394, a hard disk drive (HDD) 395, a random access memory (RAM) 396, and a communication controller 11 are connected via a bus 397 or the like. Furthermore, the computer 390 is connected to the router 20.

The ROM 394 stores a terminal identifying program that exhibits the same functions as the mail server 10 in the first embodiment. That is, as shown in FIG. 39, the ROM 394 prestores an e-mail-with-new-virus identifying program 394a, an account-information obtaining program 394b, and an infected-terminal-identification-information extracting program 394c. Similarly to the components of the mail server 10 shown in FIG. 4, these programs 394a to 394c may be integrated or separated as appropriate.

When these programs 394a to 394c are read from the ROM 394 and executed by the CPU 393, as shown in FIG. 39, the programs 394a to 394c individually function as an e-mail-with-new-virus identifying process 393a, an account-information obtaining process 393b, and an infected-terminal-identification-information extracting process 393c. These processes 393a to 393c correspond individually to the e-mail-with-new-virus identifying unit 13a, the account-information obtaining unit 13b, and the infected-terminal-identification-information extracting unit 13c shown in FIG. 4.

Furthermore, as shown in FIG. 39, the hard disk drive (HDD) 395 stores virus-definition-file data 395a, mail-archive-information data 395b, and distribution-request-history data 395c. The virus-definition-file data 395a corresponds to the virus-definition-file storage unit 12a shown in FIG. 4. The mail-archive-information data 395b corresponds to the mail-archive-information storage unit 12b. The distribution-request-history data 395c corresponds to the distribution-request-history storage unit 12e. The CPU 393 registers virus-definition-file data 396a in the virus-definition-file data 395a. The CPU 393 registers mail-archive-information data 396b in the mail-archive-information data 395b. The CPU 393 registers distribution-request-history data 396e in the distribution-request-history data 395c. The CPU 393 reads the virus-definition-file data 396a, the mail-archive-information data 396b, and the distribution-request-history data 396e. And the CPU 393 stores those pieces of data in the RAM 396. The CPU 393 executes a terminal identifying process on the basis of the virus-definition-file data 396a, the mail-archive-information data 396b, identified-e-mail-with-new-virus data 396c, obtained-account-information data 396d, and the distribution-request-history data 396e which are stored in the RAM 396.

The programs 394a to 394c need not necessarily be stored in the ROM 394 from the beginning. For example, the programs 394a to 394c may be stored on a portable physical medium that can be loaded to the computer 390, such as a flexible disk (FD), a compact disc read-only memory (CD-ROM), a magneto-optical (MO) disc, a digital versatile disc (DVD), or an IC card, or a fixed physical medium, such as a hard disk drive which is provided internally or externally to the computer 390, or another computer (or server) connected to the computer 390 via a public circuit, the Internet, a LAN, or a WAN, so that the computer 390 can read the programs and execute the programs.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A computer-readable storage medium storing a computer program for identifying a terminal infected by an e-mail with a new virus, said program causes a computer mail server to perform operations comprising:
storing information of e-mails as mail archive information;
distributing e-mails addressed to a terminal in response to a distribution request from the terminal;
storing a distribution request history associating each distribution request of an e-mail with a terminal identification information serving as terminal information identifying a terminal that issued the distribution request of the e-mail;
checking the mail archive information and identifying whether the e-mail has a new virus, when definitions of new viruses have been added in a virus definition file;
obtaining account information of the identified e-mail with the new virus; and
extracting the terminal identification information of the terminal that issued a distribution request of the e-mail with the new virus, as new-virus-infected-terminal identification information, based upon both the obtained account information and the distribution request history.

2. The computer-readable storage medium storing a computer program according to claim 1, wherein the infected-terminal-identification-information extracting extracts an IP address of the terminal as new-virus-infected-terminal identification information.

3. The computer-readable storage medium storing a computer program according to claim 1, wherein
the storing of e-mail information stores reception times of each e-mail, as pieces of the mail archive information, and
the infected-terminal-identification-information extracting extracts the new-virus-infected-terminal identification information, with a further reference to the reception time of the identified e-mail with the new virus.

4. The computer-readable storage medium storing a computer program according to claim 1,
wherein the program operations further comprise reporting the obtained account information of the identified e-mail to another mail server when the account information is not included in the distribution request history; and
wherein the infected-terminal identification information extracting extracts the new-virus-infected-terminal identification information based upon receiving a report of account information of an identified e-mail from the another mail server.

5. The computer-readable storage medium storing a computer program according to claim 2,
wherein the program operations further comprise reporting the obtained account information of the identified e-mail to another mail server when the account information is not included in the distribution request history; and
wherein the infected-terminal identification information extracting extracts the new-virus-infected-terminal identification information based upon receiving a report of account information of an identified e-mail from the another mail server.

6. The computer-readable storage medium storing a computer program according to claim 3,
wherein the program operations further comprise reporting the obtained account information of the identified e-mail to another mail server when the account information is not included in the distribution request history; and
wherein the infected-terminal identification information extracting extracts the new-virus-infected-terminal identification information based upon receiving a report of account information of an identified e-mail from the another mail server.

7. The computer-readable storage medium storing a computer program according to claim 4,
wherein the storing of e-mail information stores reception times of each e-mail, as pieces of the mail archive information, and
wherein the infected-terminal-identification-information extracting deletes information of the e-mail with the new virus from the mail archive information, when a distribution request issued by the terminal on and after the reception time is not in the distribution request history.

8. The computer-readable storage medium storing a computer program according to claim 5,
wherein the storing of e-mail information stores reception times of each e-mail, as pieces of the mail archive information, and
wherein the infected-terminal-identification-information extracting deletes information of the e-mail with the new virus from the archive information, when a distribution request issued by the terminal on and after the reception time is not included in the distribution request history.

9. The computer-readable storage medium storing a computer program according to claim 6, wherein
the infected-terminal-identification-information extracting deletes information of the e-mail with the new virus from the archive information, when a distribution request issued by the terminal on and after the reception time is not included in the distribution request history.

10. The computer-readable storage medium storing a computer program according to claims 1, wherein the infected-terminal identification extracting sends a search request of the terminal identification information to an authentication server that issues the terminal identification information to the terminal using a client user identification information for identifying a client user who operates the terminal, whenever the authentication server authenticates the terminal, and stores access management information in which the client user identification information is associated with the terminal identification information and extracts the terminal identification information received from the authentication server as the new-virus-infected-terminal identification information.

11. A computer-readable storage medium storing a computer program according to claim 2, wherein the infected-terminal identification extracting sends a search request of the terminal identification information to an authentication server that issues a terminal identification information to the terminal using a client user identification information for identifying a client user who operates the terminal, whenever the authentication server authenticates the terminal, and stores access management information in which the client user identification information is associated with the terminal identification information and extracts the terminal identification information received from the authentication server as the new-virus-infected-terminal identification information.

12. A computer-readable storage medium storing a computer program according to claim 3, wherein the infected-terminal identification extracting sends a search request of the terminal identification information to an authentication server that issues a terminal identification information to the terminal using a client user identification information for identifying a client user who operates the terminal, whenever the authentication server authenticates the terminal, and stores access management information in which the client user identification information is associated with the terminal identification information and extracts the terminal identification information received from the authentication server as the new-virus-infected-terminal identification information.

13. A computer-readable storage medium storing a computer program according to claim 4, wherein the infected-terminal identification extracting sends a search request of the terminal identification information to an authentication server that issues a terminal identification information to the terminal using a client user identification information for identifying a client user who operates the terminal, whenever the authentication server authenticates the terminal, and stores access management information and extracts the terminal identification information received from the authentication server as the new-virus-infected-terminal identification information.

14. A computer-readable storage medium storing a computer program according to claim 5, wherein the infected-terminal identification extracting sends a search request of the terminal identification information to an authentication server that issues a terminal identification information to the terminal using a client user identification information for identifying a client user who operates the terminal, whenever the authentication server authenticates the terminal, and stores access management information and extracts the terminal identification information received from the authentication server as the new-virus-infected-terminal identification information.

15. The computer-readable storage medium storing a computer program according to claim 1, wherein the program operations further comprise sending the extracted new-virus-infected-terminal identification to one or more relay devices relaying e-mails sent and received between the mail server and the terminals.

16. The computer-readable storage medium storing a computer program according to claim 2, wherein the program operations further comprise sending the extracted new-virus-infected-terminal identification to one or more relay devices relaying e-mails sent and received between the mail server and the terminals.

17. The computer-readable storage medium storing a computer program according to claim 3, wherein the program operations further comprise sending the extracted new-virus-infected-terminal identification extracted in the infected-terminal identification information to one or more relay devices relaying e-mails sent and received between the mail server and the terminals.

18. A computer-readable storage medium storing a computer program according to claim 4, wherein the program operations further comprise sending the extracted new-virus-infected-terminal identification to one or more relay devices relaying e-mails sent and received between the mail server and the terminals.

19. A terminal identifying apparatus operating in cooperation with a mail server including a virus definitions, a mail-archive-information storage unit which stores information of the e-mail as mail-archive information, a distributing unit which distributes an e-mail addressed to a terminal in response to a distribution request from the terminal, and a history storage unit which stores a distribution request history associating a distribution request of an email with terminal identification information identifying a terminal that issued distribution request of the terminal, said terminal identifying apparatus comprising:
an e-mail-with-new-virus identifying unit which checking the mail archive information in the mail server and identifies an e-mail with a new virus, when definitions of new viruses have been added in the virus definitions;
an account information obtaining unit obtaining account information of the e-mail with the new virus; and
an infected-terminal identification extracting unit extracting the terminal identification information of the terminal that issued the distribution request of the e-mail with the new virus, as new-virus-infected-terminal identification information, based upon both the obtained account information and the distribution request history in the mail server.

20. A mail system comprising:
a mail server which serves as a server of e-mails; and
one or more relay devices relaying e-mails which are sent and received between the mail server and terminals;
wherein said mail server includes
a mail archive information storage unit storing information of e-mails as mail archive information,
a distributing unit distributing e-mails addressed to the terminal in response of a distribution request from the terminal;
a history storage unit storing a distribution request history associating each distribution request of an e-mail with terminal identification information serving as information identifying a terminal that issued the distribution request of the e-mail;
an e-mail-with-new-virus identifying unit checking the mail archive information and identifies whether the e-mail has a new virus when definitions of new viruses have been added in a virus definition file;
an account-information obtaining unit obtaining account information of the e-mail with the new virus, the e-mail identified by the e-mail-with-new-virus identifying unit;
an infected-terminal-identification extracting unit extracting the terminal identification information of the terminal that issued a distribution request of the e-mail with the new virus, as new-virus-infected-terminal identification information, based upon both the obtained account information and the distribution request history; and
an infected-terminal-identification-information sending unit sending the extracted new-virus-infected-terminal identification information to the one or more relay devices; and
wherein each of said relay devices includes
an infected-terminal-identification-information receiving unit receiving the sent new-virus-infected-terminal identification information;
an infected-terminal determining unit determining whether a terminal with a new virus corresponding to the received new-virus-infected-terminal identification information is included in terminals whose traffic the relay device relays; and
a quarantining unit quarantining the new-virus-infected terminal from a network when the infected-terminal determining unit determined that the new-virus-infected-terminal is included in terminals whose traffic the relay device relays.
